(19) United States
(12) Patent Application Publication
(10) Pub. No.: US 2013/0078356 A1
(43) Pub. Date: Mar. 28, 2013

(54) PRODUCTION OF CONCENTRATED MILK FAT COMPOSITIONS AND UNITISED HIGH DENSITY COMPOSITIONS

(71) Applicants: Antony Raymond Mackereth, Palmerston North (NZ); Alan James Baldwin, Palmerston North (NZ); Willem Frank Van De Ven, Palmerston North (NZ)

(72) Inventors: Antony Raymond Mackereth, Palmerston North (NZ); Alan James Baldwin, Palmerston North (NZ); Willem Frank Van De Ven, Palmerston North (NZ)

(21) Appl. No.: 13/638,280

(22) PCT Filed: Mar. 31, 2011
(86) PCT No.: PCT/NZ11/00042

§ 371 Date: Dec. 10, 2012

Related U.S. Application Data
(60) Provisional application No. 61/319,817, filed on Mar. 31, 2010.
(60) Provisional application No. 61/319,801, filed on Mar. 31, 2010.

(51) Int. Cl. A23C 15/12; A23C 15/02

(52) U.S. Cl. CPC A23C 15/12; A23C 15/02
USPC 426/586; 426/417; 426/512

(57) ABSTRACT

The present application is directed to a method comprising; heating high fat cream, subjecting the high fat cream to shear forces, and removing water to provide a milk fat composition being a water-in-oil emulsion and comprising about 85-99.5% lipid and moisture content of about 0.05-15%. A method comprising the separation of concentrated milk fat to provide a high fat paste comprising about 1 to about 90% by weight lipid, about 0.1 to about 20% by weight moisture, and about 0.5 to about 35% phospholipid, and a milk fat concentrate comprising about 99 to about 99.9% lipid is also disclosed. In addition a method of producing a unitised high density composition comprising; providing a mixture comprising one or more liquid or semi-liquid milk fat compositions, and one or more milk powders, and compacting the mixture to produce a unitised high density composition is disclosed.

### FIELD OF THE INVENTION

The present invention relates to methods of producing concentrated milk fat compositions and unitised high density compositions produced from protein powder and lipid mixtures.

### BACKGROUND

Bovine milk comprises about 87% water by weight on average (Tetra Pak Dairy Processing Handbook, 2003) so is uneconomical to ship internationally in liquid form. Most milk that is shipped internationally is spray-dried as either whole milk powder or skim milk powder and comprises no more than 3-4% residual moisture by weight. Whole milk and skim milk powders generally have bulk densities in the order of about 0.45 to 0.57 g/ml and 0.45 to 0.6 g/ml respectively (Tetra Pak Dairy Processing Handbook, 2003). Increasing the bulk density of these products would reduce the volume to be shipped and so reduce costs.

Other protein powders, such as milk protein concentrate and whey protein concentrate powders, or non-dairy powders such as soy protein powders, have similar bulk densities when spray dried, packaged, and shipped internationally.

Bovine milk lipids are generally shipped in the form of butter, anhydrous milk fat (AMF) or anhydrous butter oil, whole milk powder, or dried speciality lipid products such as some butter milks or milk lipid fractions. Dried milk lipid fractions often have excess lactose added to improve flowability.

Traditional methods of manufacturing anhydrous milk fat include the almost complete removal of water and non-fat material by phase inversion of cream or dehydration of butter. Features of these processes that make them undesirable include the requirement for addition of water as a polishing step with associated losses, the need for recirculation of material around the phase inversion device, the potential for loss of oil-continuous phase, and the need for multiple separation steps by centrifugal devices.

It is an object of the present invention to provide an improved or alternative method of producing concentrated milk fat compositions, or to provide an improved or alternative lipid and protein product suitable for shipping, or to at least provide the public with a useful choice.

### SUMMARY OF THE INVENTION

Accordingly, in a first aspect the invention relates to a method of producing a concentrated milk fat composition, the method comprising

(1) providing a high fat cream that is an oil-in-water emulsion comprising about 38 to about 85% by weight lipid and a moisture content of about 10 to about 62% by weight, and optionally comprising an added source of phospholipid,
(2) heating the high fat cream to a temperature higher than the melting point of the lipid and lower than the smoke point of the lipid,
(3) subjecting the high fat cream to shear forces to convert the oil-in-water emulsion into a water-in-oil emulsion, and
(4) removing water from the high fat cream by evaporation, absorption, supercritical extraction or liquid-liquid extraction,
the concentrated milk fat composition being a water-in-oil emulsion comprising about 85 to about 99.5% by weight lipid and a moisture content of about 0.05 to about 15% by weight.

In one embodiment the method comprises heating high fat cream, subjecting the high fat cream to shear and removing water from the high fat cream in one step. In this embodiment the step may be carried out using agitated thin film evaporation or wiped film evaporation.

In another embodiment the method comprises heating high fat cream in a first step, subjecting the high fat cream to shear forces in a second step and removing water from the high fat cream in a third step. These steps may be conducted in the stated order or concurrently. The second step or the third step or both the second and third steps optionally include heating the high fat cream, as described above. In this embodiment the first step may comprise steam infusion, direct steam injection or contacting the high fat cream with a heat exchanger. In this embodiment the second step may comprise contacting the high fat cream with a device, such as a homogeniser, a pump, such as a centrifugal pump, a centripetal pump or a positive displacement pump or an evaporator, that subjects the high fat cream to shear forces. In this embodiment the third step may comprise liquid-liquid extraction, absorption such as by addition of or contact with one or more desiccants, supercritical extraction, or evaporation with an evaporator such as falling film evaporation, flash evaporation, thin film evaporation, or wiped film evaporation, or any combination of any two or more thereof. Liquid-liquid extraction includes but is not limited to extraction with one or more food grade solvents including but not limited to ethanol, hexane, acetone, carbon dioxide and dimethyl ether, or any combination of any two or more thereof. Useful desiccants include but are not limited to any food grade desiccant selected from a dietary fibre, modified starch, polydextrose, silica based powders or earths (including but not limited to diatomaceous earth and silica powders), activated carbon, inulin, and pectin, or any combination of any two or more thereof. In any embodiment requiring a desiccant and/or solvent, the method may further comprise a step or steps to remove the desiccant and/or solvent, including but not limited to filtration, centrifugation, decanting, sedimentation, and the like, or any combination of any two or more thereof. Supercritical extraction includes but is not limited to extraction with one or more food grade solvents including but not limited to supercritical carbon dioxide and supercritical dimethyl ether, or a combination thereof.

In an alternative embodiment the method comprises heating high fat cream and subjecting the high fat cream to shear forces in a first step and removing water from the high fat cream in a second step or concurrently with the first step. The second step optionally includes heating the high fat cream. In this embodiment the first step may comprise direct steam injection sufficient to phase invert the high fat cream. In this embodiment the second step may comprise liquid-liquid extraction, absorption such as by addition of one or more desiccants, supercritical extraction, or evaporation with an evaporator such as falling film evaporation, flash evaporation, thin film evaporation, or wiped film evaporation, or any combination of any two or more thereof.

In yet another embodiment the method comprises heating high fat cream in a first step and subjecting the high fat cream to shear forces and removing water from the high fat cream in a second step or concurrently with the first step. The second step optionally includes heating the high fat cream. In this embodiment the first step may comprise steam infusion, direct steam injection, or contacting the high fat cream with a heat exchanger. In this embodiment the second step may comprise multiple stage flash evaporation, agitated thin film evaporation, or wiped film evaporation.

In a second aspect, the invention relates to a method of producing a milk fat concentrate and a high fat paste concentrate, the method comprising

(1) providing a concentrated milk fat composition that is a water-in-oil emulsion comprising about 85% to about 99.5% by weight lipid and a moisture content of about 0.05 to about 15% by weight, at a temperature of about 17° C. to about 177° C., and optionally comprising an added source of phospholipid, and
(2) subjecting the concentrated milk fat composition to one or more separation steps to produce a high fat paste concentrate and a milk fat concentrate,
the high fat paste concentrate comprising about 1 to about 90% by weight lipid, about 0.1 to about 20% by weight moisture, and about 0.5 to about 35%, or about 0.5 to about 6%, or about 0.5 to about 4% by weight phospholipid,
the milk fat concentrate comprising about 99 to about 99.9% by weight lipid.

In a third aspect the invention relates to a method of producing a unitised high density composition, the method comprising

(1) providing a mixture comprising, consisting of or consisting essentially of
(a) one or more liquid or semi-liquid milk fat compositions, and
(b) one or more milk powders, and
   (2) compacting the mixture to produce a unitised high density composition having a volume of at least about 50 cm³ and a density of at least about 50% of the material density of the mixture.

In one embodiment the one or more liquid or semi-liquid milk fat compositions comprises a water-in-oil emulsion. In another embodiment the one or more liquid or semi-liquid milk fat compositions is a water-in-oil emulsion. In yet another embodiment the one or more liquid or semi-liquid milk fat compositions is a combination of a water-in-oil emulsion and a solid or semi-solid lipid, optionally a solid or semi-solid lipid suspended in oil. In a further embodiment the one or more liquid or semi-liquid milk fat compositions is a concentrated milk fat composition, as described herein. In still another embodiment the one or more liquid or semi-liquid milk fat compositions comprises a mixture of a high fat paste concentrate and a concentrated milk fat composition or a milk fat concentrate or both, as described herein.

In one embodiment the one or more liquid or semi-liquid milk fat compositions comprises or together comprise about 85% to about 99.95% by weight lipid and a moisture content of about 0.01 to about 15% by weight.

In one embodiment the ratio of the one or more milk fat compositions to the one or more milk powders is about 10:90, 15:85, 20:80, 25:75, 30:70, 35:65, 40:60 or 45:55, and useful ranges may be selected between any of these values (for example, about 10:90 to about 45:55, about 10:90 to about 40:60, about 15:85 to about 40:60, about 20:80 to about 40:60, about 25:75 to about 40:60, about 30:70 to about 40:60, about 10:90 to about 35:65, about 15:85 to about 35:65, about 20:80 to about 35:65, about 25:75 to about 35:65, and about 30:70 to about 35:65).

In a fourth aspect the invention relates to a unitised high density composition comprising, consisting of or consisting essentially of a cohesive mixture of one or more milk powders and one or more milk fat compositions, the unitised high density composition having

(1) a volume of at least about 50 cm³,
(2) a density of at least about 50% of the material density of the cohesive mixture, and
(3) a moisture content of less than about 15% by weight.

In one embodiment the unitised high density composition has a solubility index of less than about 5 mL. The solubility index is determined according to ADMI Solubility Index Test IDF Standard 129A (1988). In such an embodiment the milk powder may, for example, be a whole milk powder or a skim milk powder but other powders are contemplated.

In one embodiment the ratio of the one or more milk fat compositions to the one or more milk powders in the unitised high density composition is about 10:90, 15:85, 20:80, 25:75, 30:70, 35:65, 40:60 or 45:55, and useful ranges may be selected between any of these values (for example, about 10:90 to about 45:55, about 10:90 to about 40:60, about 15:85 to about 40:60, about 20:80 to about 40:60, about 25:75 to about 40:60, about 30:70 to about 40:60, about 10:90 to about 35:65, about 15:85 to about 35:65, about 20:80 to about 35:65, about 25:75 to about 35:65, and about 30:70 to about 35:65).

In some embodiments the unitised high density composition comprises about 3 to about 90% by weight milk protein and about 10 to about 70% by weight milk lipid provided by the combination of the one or more milk powders and the one or more liquid or semi-liquid milk fat compositions.

In a fifth aspect the invention relates to a concentrated milk fat composition that is a water-in-oil emulsion comprising about 85 to 99.5% by weight milk lipid, about 0.1 to 5% by weight milk protein, about 0 to 5% by weight lactose and less than about 15% by weight moisture.

In a sixth aspect the invention relates to a high fat paste concentrate comprising at least about 1 to 90% by weight milk lipid, about 0.5 to about 35% by weight phospholipid, about 0.5 to 10% by weight milk protein, about 0 to 15% by weight lactose and less than about 20% by weight moisture.

The following embodiments, alone or in combination may relate to any of the above aspects.

In one embodiment the high fat cream comprises at least about 38, 40, 45, 50, 55, 60, 65, 70, 75, 80 or 85% by weight lipid, and useful ranges may be selected between any of these values (for example, about 38 to about 45, about 38 to about 50, about 38 to about 55, about 38 to about 60, about 38 to about 65, about 38 to about 70, about 38 to about 75, about 38 to about 80, about 38 to about 85, about 40 to about 55, about 40 to about 60, about 40 to about 65, about 40 to about 70, about 40 to about 75, about 40 to about 80, about 40 to about 85, about 50 to about 55, about 50 to about 60, about 50 to about 65, about 50 to about 70, about 50 to about 75, about 50 to about 80, about 50 to about 85, about 60 to about 75, about 60 to about 85, and about 70 to about 85% by weight lipid).

In one embodiment the high fat cream comprises a moisture content of less than about 10, 15, 20, 25, 30, 35, 40, 45, 50, 55, 60 or 62% by weight, and useful ranges may be selected between any of these values (for example, about 10 to about 25, about 10 to about 30, about 10 to about 35, about 10 to about 40, about 10 to about 45, about 10 to about 50, about 10 to about 55, about 10 to about 60, about 10 to about 62, about 15 to about 25, about 15 to about 30, about 15 to about 35, about 15 to about 40, about 15 to about 45, about 15 to about 50, about 15 to about 55, about 15 to about 60 and about 15 to about 62% by weight moisture).

As noted above, the step of heating the high fat cream comprises heating it to a temperature higher than the melting point of the lipid and lower than the smoke point of the lipid. The heating may be done in one or more steps. In one embodiment the high fat cream is heated to a temperature of at least about 32, 35, 40, 45, 50, 55, 60, 65, 70, 75, 80, 85, 90, 95, 100, 105, 110, 115, 120, 125, 130, 135, 140, 145, 150, 155, 160, 165, 170 or 177° C., and useful ranges may be selected between these values (for example, about 32 to about 177, about 40 to about 177, about 50 to about 177, about 60 to about 177, about 70 to about 177, about 80 to about 177, about 32 to about 160, about 40 to about 160, about 50 to about 160, about 60 to about 160, about 65 to about 160, about 70 to about 160, about 80 to about 160, about 32 to about 140, about 40 to about 140, about 50 to about 140, about 60 to about 140, about 65 to about 140, about 70 to about 140, about 80 to about 140, about 32 to about 130, about 40 to about 130, about 50 to about 130, and about 60 to about 130° C.). The method may further comprise a pre-heating step, wherein the high fat cream is heated to a first temperature, being a temperature or within a temperature range described above, and then heated to a second temperature, also being a temperature or within a temperature range described above.

In one embodiment, the method of producing a concentrated milk fat composition further comprises preheating the high fat cream to a temperature of about 17° C. to about 130° C., optionally for about 0.5 seconds to about 100 seconds, and useful ranges may be selected between any of these values.

In one embodiment, the method of producing a concentrated milk fat composition comprises cooling the high fat cream to at least about 20, 30, 40, 50, 60, 70, 80, 90, 100 or 105° C. to produce a concentrated milk fat composition, and useful ranges may be selected between any of these values (for example, about 20 to about 105, about 20 to about 100, about 20 to about 65, or about 35 to about 50° C.).

In one embodiment of a method of producing a concentrated milk fat composition, the shear forces are imparted by a device including but not limited to a homogeniser, a pump such as a centrifugal pump, a centripetal pump, a positive displacement pump, direct steam injection, agitated thin film evaporation, wiped film evaporation, or any combination of any two or more thereof.

In one embodiment water removal from the high fat cream is achieved by evaporation, absorption, supercritical extraction or liquid-liquid extraction, or any combination of any two or more thereof.

Evaporation may be falling film evaporation, flash evaporation, thin film evaporation or wiped film evaporation. Preferably the evaporation is thin film evaporation or agitated thin film evaporation.

Liquid-liquid extraction may include but is not limited to extraction with one or more food grade solvents or potential food grade solvents such as ethanol, hexane, acetone, carbon dioxide and dimethyl ether, or any combination of any two or more thereof.

Absorption includes the addition of one or more desiccants including but not limited to any food grade desiccant selected from a dietary fibre, modified starch, polydextrose, silica based powders or earths (including but not limited to diatomaceous earth and silica powders), activated carbon, inulin, and pectin, or any combination of any two or more thereof.

Supercritical extraction includes the use of a supercritical food grade solvent such as supercritical carbon dioxide or supercritical dimethyl ether.

In one embodiment of a method of producing a concentrated milk fat composition, the step of removing water from the high fat cream by evaporation comprises conducting evaporation with

(1) a saturated water vapour temperature of about 30 to about 120° C., about 45 to about 101° C., or about 50 to about 70° C., or
(2) a product contact wall temperature of about 40 to about 177° C., about 50 to about 140° C., or about 70 to about 130° C., or
(3) a product temperature of about 40 to about 177° C., about 50 to about 150° C., about 70 to about 105° C., or about 85 to about 100° C., or
(4) a product exit temperature of about 20 to about 105° C. or about 20 to about 100° C., or
(5) any combination of any two or more thereof.

In one embodiment the concentrated milk fat composition comprises at least about 85, 86, 87, 88, 89, 90, 91, 92, 93, 94, 95, 96, 97, 98, 99 or 99.5% by weight lipid, and useful ranges may be selected between any of these values (for example, about 85 to about 99.5, about 86 to about 99.5, about 87 to about 99.5, about 88 to about 99.5, about 89 to about 99.5, about 90 to about 99.5, about 91 to about 99.5, about 92 to about 99.5, about 93 to about 99.5, about 94 to about 99.5, about 95 to about 99.5, about 96 to about 99.5, about 97 to about 99.5, about 98 to about 99.5, about 85 to about 98, about 86 to about 98, about 87 to about 98, about 88 to about 98, about 89 to about 98, about 90 to about 98, about 91 to about 98, about 92 to about 98, about 93 to about 98, about 94 to about 98, about 95 to about 98, about 96 to about 98, and about 97 to about 98% by weight lipid).

In one embodiment the concentrated milk fat composition comprises about 0.5, 1, 1.5, 2, 2.5, 3, 3.5, 4, 4.5, 5, 5.5, 6, 6.5, 7, 7.5, 8, 8.5, 9, 9.5, 10, 15, 20, 25, 30 or 35% by weight phospholipid, and useful ranges may be selected between any of these values (for example, about 0.5 to about 35, about 0.5 to about 20, about 0.5 to about 10, about 0.5 to about 8, about 0.5 to about 6, and about 0.5 to about 4%).

In one embodiment the concentrated milk fat composition comprises about 0.1, 0.5, 1, 1.5, 2, 2.5, 3, 3.5, 4, 4.5 or 5% protein by weight, and useful ranges may be selected between any of these values (for example, about 0.1 to about 1, about 0.1 to about 2, about 0.1 to about 3, about 0.1 to about 4 and about 0.1 to about 5%).

In one embodiment the concentrated milk fat composition comprises about 0, 0.1, 0.5, 1, 1.5, 2, 2.5, 3, 3.5, 4, 4.5 or 5% lactose by weight, and useful ranges may be selected between any of these values (for example, about 0 to about 1, about 0 to about 2, about 0.1 to about 1, about 0.1 to about 2, about 0.1 to about 3, about 0.1 to about 4 and about 0.1 to about 5%).

In one embodiment the concentrated milk fat composition comprises a moisture content of less than about 0.01, 0.05, 0.1, 0.15, 0.2, 0.25, 0.3, 0.35, 0.4, 0.45, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5 or 15% by weight, and useful ranges may be selected between any of these values (for example, about 0.01 to about 1, 0.01 to about 2, about 0.01 to about 4, about 0.01 to about 6, about 0.01 to about 8, about 0.01 to about 10, about 0.01 to about 12, about 0.01 to about 15, about 0.05 to about 1, 0.05 to about 2, about 0.05 to about 4, about 0.05 to about 6, about 0.05 to about 8, about 0.05 to about 10, about 0.05 to about 12, about 0.05 to about 15, about 0.15 to about 0.5, about 0.15 to about 1, 0.15 to about 2, about 0.15 to about 4, about 0.15 to about 6, about 0.15 to about 8, about 0.15 to about 10, about 0.15 to about 12 and about 0.15 to about 15% by weight). In one embodiment the concentrated milk fat composition is dried, preferably vacuum dried. Depending on the moisture content of the concentrated milk fat composition, in some embodiments the moisture content is reduced by the drying step to less than about 0.01, 0.05, 0.1, 0.15, 0.2, 0.25, 0.3, 0.35, 0.4, 0.45 or 0.5% by weight, and useful ranges may be selected between any of these values (for example, about 0.01 to about 0.5, 0.01 to about 0.4, about 0.01 to about 0.3, about 0.01 to about 0.2, about 0.01 to about 0.1% by weight).

In one embodiment the concentrated milk fat composition is provided at a temperature of at least about 17, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170 or 177° C., and useful ranges may be selected from any of these values (for example, about 45 to about 85, about 50 to about 70 and about 55 to about 70, about 17 to about 177, about 20 to about 177, about 25 to about 177, about 30 to about 177, about 35 to about 177, about 40 to about 177, about 50 to about 177, about 60 to about 177, about 70 to about 177, about 80 to about 177, about 17 to about 160, about 20 to about 160, about 25 to about 160, about 30 to about 160, about 35 to about 160, about 40 to about 160, about 50 to about 160, about 60 to about 160, about 65 to about 160, about 70 to about 160, about 80 to about 160, about 17 to about 140, about 20 to about 140, about 25 to about 140, about 30 to about 140, about 35 to about 140, about 40 to about 140, about 50 to about 140, about 60 to about 140, about 65 to about 140, about 70 to about 140, about 80 to about 140, about 60 to about 130, about 17 to about 100, about 20 to about 100, about 30 to about 100, about 35 to about 100, about 40 to about 100, about 50 to about 100, about 60 to about 100, about 70 to about 100, and about 80 to about 100° C.).

In one embodiment the step of subjecting the concentrated milk fat composition to one or more separation steps comprises one or more of contacting the concentrated milk fat composition with a separator, liquid-liquid extraction, absorption such as by addition of one or more desiccants, supercritical extraction, or evaporation with an evaporator such as falling film evaporation, flash evaporation, thin film evaporation, or wiped film evaporation, or any combination of any two or more thereof. Useful solvents for liquid-liquid extraction and supercritical extraction and useful desiccants are described above. Contacting the concentrated milk fat composition with a separator may comprise contacting the concentrated milk fat composition with a plate and frame filter, a leaf filter, a basket centrifuge, a decanter, a centrifugal separator, or a belt filter, or any combination of any two or more thereof.

In one embodiment the high fat paste concentrate comprises at least about 1, 5, 10, 15, 20, 25, 30, 35, 40, 45, 50, 55, 60, 65, 70, 75, 80, 85 or 90% by weight lipid, and useful ranges may be selected between any of these values (for example, about 1 to about 90, about 10 to about 90, about 20 to about 90, about 30 to about 90, about 40 to about 90, about 50 to about 90, about 1 to about 80, about 10 to about 80, about 20 to about 80, about 30 to about 80, about 40 to about 80, and about 50 to about 80%).

In one embodiment the high fat paste concentrate comprises less than about 0.1, 0.2, 0.3, 0.4, 0.5, 0.6, 0.7, 0.8, 0.9, 1, 1.2, 1.4, 1.6, 1.8, 2, 2.5, 3, 3.5, 4, 4.5, 5, 10, 15 or 20% by weight moisture, and useful ranges may be selected between any of these values (for example, about 0.1 to about 20, about 0.5 to about 20, about 1 to about 20, about 0.1 to about 10, about 0.5 to about 10, about 1 to about 10, about 0.1 to about 5, about 0.2 to about 5, about 0.3 to about 5, about 0.4 to about 5, about 0.5 to about 5, about 1 to about 5, about 0.1 to about 2, about 0.2 to about 2, about 0.3 to about 2, about 0.4 to about 2, and about 0.5 to about 2%).

In one embodiment the high fat paste concentrate comprises about 0.5, 1, 1.5, 2, 2.5, 3, 3.5, 4, 4.5, 5, 5.5, 6, 6.5, 7, 7.5, 8, 8.5, 9, 9.5, 10, 15, 20, 25, 30 or 35% by weight phospholipid, and useful ranges may be selected between any of these values (for example, about 0.5 to about 35, about 0.5 to about 20, about 0.5 to about 10, about 0.5 to about 8, about 0.5 to about 6, and about 0.5 to about 4%).

In one embodiment the high fat paste concentrate comprises about 0.5, 1, 1.5, 2, 2.5, 3, 3.5, 4, 4.5, 5, 5.5, 6, 6.5, 7, 7.5, 8, 8.5, 9, 9.5 or 10% by weight protein, and useful ranges may be selected between any of these values (for example, about 0.5 to about 10, about 0.5 to about 9, about 0.5 to about 8, about 0.5 to about 6, and about 0.5 to about 4%).

In one embodiment the high fat paste concentrate comprises about 0, 0.1, 0.5, 1, 1.5, 2, 2.5, 3, 3.5, 4, 4.5, 5, 5.5, 6, 6.5, 7, 7.5, 8, 8.5, 9, 9.5, 10 or 15% by weight lactose, and useful ranges may be selected between any of these values (for example, about 0.5 to about 15, about 0.5 to about 10, about 0.5 to about 8, about 0.5 to about 6, and about 0.5 to about 4%).

In one embodiment the high fat paste concentrate is formed into a crumbed particle, such as by milling or grinding, and optionally vacuum packed.

In one embodiment the milk fat concentrate comprises about 99, 99.05, 99.1, 99.15, 99.2, 99.25, 99.3, 99.35, 99.4, 99.45, 99.5, 99.55, 99.6, 99.65, 99.7, 99.75, 99.8, 99.85, or 99.9% by weight lipid, and useful ranges may be selected between any of these values (for example, about 99 to about 99.9, about 99.1 to about 99.9, about 99.2 to about 99.9, about 99.3 to about 99.9, about 99.4 to about 99.9, about 99.5 to about 99.9, about 99.6 to about 99.9, and about 99.7 to about 99.9%).

In some embodiments the milk fat concentrate is subjected to vacuum drying. In such embodiments a lipid concentration of about 99% by weight or greater may be increased to about 99.5, about 99.8 or about 99.9% by weight or greater.

Referring to the method of producing a unitised high density composition, in one embodiment the liquid or semi-liquid milk fat composition comprises a concentrated milk fat composition or combination of a high fat paste and a milk fat concentrate. Use of any suitable milk fat compositions is also contemplated. In relation to such methods, discussion of a concentrated milk fat composition above also applies to a milk fat composition incorporated into the unitised high density composition.

In one embodiment, production of the unitised high density composition further comprises a mixing step. In some embodiments mixing and compacting may be simultaneous (for example, extrusion). In other embodiments mixing and compacting may be sequential (for example, mixing, moulding and compressing in batches). In still other embodiments compaction may be carried out in multiple stages (for example, pre-compaction followed by compaction). It should be understood that the compaction step may be carried out using any suitable equipment for batch or continuous processing that is able to shape the cohesive mixture and apply pressure to the cohesive mixture to achieve the required density.

In one embodiment the milk powder comprises, consists essentially of, or consists of whole milk powder, low fat milk powder, skim milk powder, buttermilk powder, milk protein concentrate (MPC) powder, whey protein concentrate (WPC) or whey protein isolate (WPI) powder, a hydrolysate thereof, or any combination of any two or more thereof. The milk powder may be a non-agglomerated, agglomerated, roll-compacted, freeze dried, drum dried, spray dried or foam spray dried milk powder.

In one embodiment the milk powder has a density of at least about 0.2, 0.25, 0.3, 0.35, 0.4, 0.45, 0.5, 0.55, 0.6, 0.65, 0.7, 0.75 or 0.8 g/ml, and useful ranges may be selected between any of these values (for example, about 0.2 to about 0.4, about 0.2 to about 0.6, about 0.2 to about 0.7, about 0.2 to about 0.8, about 0.3 to about 0.8, about 0.35 to about 0.8 g/ml).

In various embodiments the milk powder may be shaped, milled, sieved, or any combination thereof.

In one embodiment the milk powder comprises less than about 0.05, 0.1, 0.5, 1, 2, 3, 4, 5, 6, 7, 8, 9, 10, 11 or 12% moisture by weight, and useful ranges may be selected between any of these values (for example, about 0.05 to about 1, about 0.05 to about 2, about 0.05 to about 3, about 0.05 to about 4, about 0.05 to about 5, about 0.05 to about 6, about 0.05 to about 7, about 0.05 to about 8, about 0.05 to about 9, about 0.05 to about 10, about 0.05 to about 11, and about 0.05 to about 12%).

In various embodiments the milk powder comprises at least about 5, 10, 15, 20, 25, 30, 35, 40, 45, 50, 55, 60, 65, 70, 75, 80, 85, 90, 95 or 99% by weight protein, and useful ranges may be selected between any of these values (for example, about 5 to about 95, about 10 to about 95, about 20 to about 95, about 30 to about 95, about 40 to about 95, about 50 to about 95, about 60 to about 95, about 5 to about 99, about 10 to about 99, and about 70 to about 99% by weight protein).

In various embodiments the milk powder comprises at least about 0.1, 1, 2, 3, 4, 5, 6, 7, 8, 9, 10, 12, 14, 15, 16, 18, 20, 22, 24, 25, 26, 28, 30, 32, 34, 35, 36, 38, 40, 42, 44, 45, 46, 48 or 50% by weight lipid, and useful ranges may be selected between any of these values (for example, about 0.1 to about 2, about 0.1 to about 40, about 0.1 to about 50, about 1 to about 6, about 1 to about 10, about 1 to about 20, about 1 to about 30, about 1 to about 40, about 1 to about 50, about 20 to about 50, about 24 to about 42, or about 26 to about 40% by weight lipid).

In various embodiments the milk powder has a solubility index of less than about 0.1, 0.25, 0.5, 0.75, 1, 1.25, 1.5, 2, 2.5, 3, 3.5, 4, 4.5 or 5 mL, and useful ranges may be selected between any of these values (for example, about 0.1 to about 5, about 0.5 to about 5, about 1 to about 5, about 2 to about 5, about 3 to about 5, about 0.1 to about 4, about 0.5 to about 4, about 1 to about 4, about 2 to about 4, about 0.1 to about 3, about 0.5 to about 3, and about 1 to about 3 mL). The solubility index is determined according to ADMI Solubility Index Test IDF Standard 129A (1988).

In various embodiments the addition of the one or more liquid or semi-liquid milk fat compositions to the one or more milk powders changes the solubility index of the one or more milk powders by less than about 1, 5, 10, 15 or 20%, and useful ranges may be selected between any of these values (for example, about 1 to about 10, about 1 to about 15 or about 1 to about 20%). In other embodiments the addition of the one or more liquid or semi-liquid milk fat compositions to the one or more milk powders changes the solubility index of the one or more milk powders by less than about 0.1, 0.5, 1, 1.5 or 2 mL, and useful ranges may be selected between any of these values (for example, about 0.1 to about 0.5, about 0.1 to about 1, about 0.1 to about 1.5, and about 0.1 to about 2 mL). The solubility index is determined according to ADMI Solubility Index Test IDF Standard 129A (1988).

In one embodiment the one or more milk fat compositions are optionally heated before being mixed with one or more milk powders to a temperature of about 17, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170 or 177° C., and useful ranges may be selected between these values (for example, about 17 to about 177, about 20 to about 177, about 25 to about 177, about 30 to about 177, about 35 to about 177, about 40 to about 177, about 50 to about 177, about 60 to about 177, about 70 to about 177, about 80 to about 177, about 17 to about 160, about 20 to about 160, about 25 to about 160, about 30 to about 160, about 35 to about 160, about 40 to about 160, about 50 to about 160, about 60 to about 160, about 65 to about 160, about 70 to about 160, about 80 to about 160, about 17 to about 140, about 20 to about 140, about 25 to about 140, about 30 to about 140, about 35 to about 140, about 40 to about 140, about 50 to about 140, about 60 to about 140, about 65 to about 140, about 70 to about 140, about 80 to about 140, about 60 to about 130, about 40 to about 90, about 40 to about 80, about 45 to about 80, about 45 to about 75 and about 45 to about 65° C.).

In one embodiment the one or more milk powders are optionally heated before being mixed with the one or more liquid or semi-liquid milk fat compositions to a temperature of about 15, 20, 25, 30, 35, 40, 45, 50, 55, 60, 65 or 70° C., and useful ranges may be selected between these values (for example, about 15 to about 70, about 15 to about 60, about 30 to about 50, or about 30 to about 45° C.). In another embodiment the one or more milk powders are optionally provided at such a temperature or temperature range before being mixed with the one or more liquid or semi-liquid milk fat compositions.

In various embodiments the unitised high density composition comprises at least about 1, 2, 3, 4, 5, 6, 10, 15, 20, 25, 30, 35, 40, 45, 50, 55, 60, 65, 70, 75, 80, 85, or 90% by weight protein, and useful ranges may be selected between any of these values (for example, about 3 to about 90, about 5 to about 90, about 10 to about 90, about 15 to about 90, about 20 to about 90, about 25 to about 90, about 30 to about 90, about 35 to about 90, about 40 to about 90, about 45 to about 90, about 50 to about 90, about 3 to about 85, about 5 to about 85, about 10 to about 85, about 15 to about 85, about 20 to about 85, about 25 to about 85, about 30 to about 85, about 35 to about 85, about 40 to about 85, about 45 to about 85, about 50 to about 85, about 3 to about 70, about 10 to about 70, about 15 to about 70, about 20 to about 70, about 25 to about 70, about 30 to about 70, about 35 to about 70, about 40 to about 70, about 45 to about 70, about 50 to about 70, about 10 to about 60, about 20 to about 60, about 30 to about 60, about 10 to about 50, about 20 to about 50, about 10 to about 40, and about 20 to about 40% by weight protein).

In various embodiments the unitised high density composition comprises at least about 1, 5, 8, 10, 15, 20, 25, 30, 35, 40, 45, 50, 55, 60, 65 or 70% by weight lipid, and useful ranges may be selected between any of these values (for example, about 1 to about 70, about 5 to about 70, about 10 to about 70, about 15 to about 70, about 20 to about 70, about 25 to about 70, about 30 to about 70, about 35 to about 70, about 40 to about 70, about 45 to about 70, about 50 to about 70, about 1 to about 65, about 5 to about 65, about 10 to about 65, about 15 to about 65, about 20 to about 65, about 25 to about 65, about 30 to about 65, about 35 to about 65, about 40 to about 65, about 45 to about 65, about 50 to about 65, about 10 to about 60, about 20 to about 60, about 30 to about 60, about 10 to about 50, about 20 to about 50, about 10 to about 40, and about 20 to about 40% by weight lipid).

In some embodiments the unitised high density composition comprises about 10 to about 60, about 20 to about 60, about 30 to about 60, about 10 to about 50, about 20 to about 50, about 10 to about 40, or about 20 to about 40% by weight lipid and about 10 to about 90, about 10 to about 60, about 20 to about 60, about 30 to about 60, about 10 to about 50, about 20 to about 50, about 10 to about 40, or about 20 to about 40% by weight protein.

In various embodiments the unitised high density composition comprises a volume of at least about 50, 51, 55, 60, 65, 70, 75, 80, 85, 90, 95, 100, 200, 300, 400, 500, 600, 700, 800, 900, 1000, 2500, 5000, 7500, 10,000, 12,500, 15,000, 17,500, 20,000, 22,500, 25,000, 27,500, 30,000, 35,000, 40,000, 45,000, 50,000, 60,000, 70,000, 80,000, 90,000 or 100,000 cm³, and useful ranges may be selected between any of these values (for example, about 50 to about 30,000, about 100 to about 30,000, about 200 to about 30,000, about 400 to about 30,000, about 600 to about 30,000, about 800 to about 30,000, about 1000 to about 30,000, about 2000 to about 30,000, about 4000 to about 30,000, about 6000 to about 30,000, about 8000 to about 30,000, about 10,000 to about 30,000, about 15,000 to about 30,000, about 20,000 to about 30,000, about 50 to about 50,000, about 100 to about 50,000, about 200 to about 50,000, about 400 to about 50,000, about 600 to about 50,000, about 800 to about 50,000, about 1000 to about 50,000, about 2000 to about 50,000, about 4000 to about 50,000, about 6000 to about 50,000, about 8000 to about 50,000, about 10,000 to about 50,000, about 15,000 to about 50,000, about 20,000 to about 50,000, about 50 to about 75,000, about 100 to about 75,000, about 200 to about 75,000, about 400 to about 75,000, about 600 to about 75,000, about 800 to about 75,000, about 1000 to about 75,000, about 2000 to about 75,000, about 4000 to about 75,000, about 6000 to about 75,000, about 8000 to about 75,000, about 10,000 to about 75,000, about 15,000 to about 75,000, about 20,000 to about 75,000, about 50 to about 100,000, about 100 to about 100,000, about 200 to about 100,000, about 400 to about 100,000, about 600 to about 100,000, about 800 to about 100,000, about 1000 to about 100,000, about 2000 to about 100,000, about 4000 to about 100,000, about 6000 to about 100,000, about 8000 to about 100,000, about 10,000 to about 100,000, about 15,000 to about 100,000, and about 20,000 to about 100,000 cm³).

In one embodiment, the density of the unitised high density composition comprises at least about 50, 55, 60, 65, 70, 75, 80, 85, 90, 95 or 100% of the material density of the components of the composition, and useful ranges may be selected between these values (for example, about 50 to about 100, about 55 to about 100, about 60 to about 100, about 65 to about 100, about 70 to about 100, about 75 to about 100, about 80 to about 100, about 85 to about 100, about 90 to about 100, about 60- to about 90, about 65 to about 90, about 70 to about 90, about 75 to about 90, about 80 to about 90, or about 85 to about 90%).

In various embodiments the density of the unitised high density composition is at least about 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, 1.1, 1.11, 1.12, 1.13, 1.14, 1.15, 1.16, 1.17, 1.18, 1.19, 1.2, 1.3, 1.4, or 1.5 g/mL, and useful ranges may be selected between these values (for example, about 0.5 to about 1.5, about 0.6 to about 1.4, about 0.7 to about 1.3, about 0.5 to about 1.2, about 0.6 to about 1.2, about 0.7 to about 1.2, about 0.8 to about 1.2, about 0.81 to about 1.2, about 0.82 to about 1.2, about 0.83 to about 1.2, about 0.84 to about 1.2, about 0.85 to about 1.2, about 0.86 to about 1.2, about 0.87 to about 1.2, about 0.88 to about 1.2, about 0.89 to about 1.2 and about 0.9 to about 1.2 g/ml).

In various embodiments the unitised high density composition comprises a moisture content of about 0.1, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14 or 15% by weight or less, and useful ranges may be selected between any of these values (for example, about 0.1 to about 1, about 0.1 to about 2, about 0.1 to about 3, about 0.1 to about 4, about 0.1 to about 5, about 0.1 to about 6, about 0.1 to about 7, about 0.1 to about 8, about 0.1 to about 9, about 0.1 to about 10, about 0.1 to about 15, about 1 to about 2, about 1 to about 3, about 1 to about 4, about 1 to about 5, about 1 to about 6, about 1 to about 7, about 1 to about 8, about 1 to about 9, about 1 to about 10, about 1 to about 15, about 1.5 to about 3, about 1.5 to about 4, about 1.5 to about 5, about 1.5 to about 6, about 1.5 to about 7, about 1.5 to about 8, about 1.5 to about 9, about 1.5 to about 10 and about 1.5 to about 15% by weight moisture or less).

In various embodiments the unitised high density composition comprises a solubility index of about 0.05, 0.1, 0.5, 1, 1.5, 2, 2.5, 3, 3.5, 4, 4.5 or 5 mL as determined by ADMI Solubility Index Test IDF Standard 129A (1988), and useful ranges may be selected between these values (for example, about 0.05 to about 5, about 0.1 to about 5, about 0.5 to about 5, about 1 to about 5, about 2 to about 5, about 3 to about 5, about 0.1 to about 4, about 0.5 to about 4, about 1 to about 4, about 2 to about 4, about 0.1 to about 3, about 0.5 to about 3, and about 1 to about 3 mL).

In one embodiment the unitised high density composition is a free standing block.

In one embodiment of a method described above, the composition produced by the method is packaged, preferably vacuum packaged. In various embodiments, packaging is conducted in an inert atmosphere. In one embodiment a plurality of the packaged compositions are loaded onto a pallet or into a shipping container. In another embodiment of a method described above, the method further comprises packaging one or more unitised high density compositions, preferably vacuum packaging one or more unitised high density compositions. In various embodiments 1, 2, 3, 4, 5, 6, 7, 8, 9, 10, 11, 12, 13, 14, 15, 16, 17, 18, 19 or 20 blocks or more are packaged together in one package, and useful ranges may be selected between these values (for example, about 1 to about 20). In various embodiments, packaging is conducted in an inert atmosphere. In one embodiment a plurality of the packaged compositions are loaded onto a pallet or into a shipping container in a standardised fashion to maximise utilisation of space.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

To those skilled in the art to which the invention relates, many changes in construction and differing embodiments and applications of the invention will suggest themselves without departing from the scope of the invention as defined in the appended claims. The disclosures and the descriptions herein are purely illustrative and are not intended to be in any sense limiting.

### DESCRIPTION OF THE FIGURES

FIG. 1 is a flow diagram showing production of a concentrated milk fat composition from high fat cream and optional production of a high fat paste and a milk fat concentrate from a concentrated milk fat composition.

FIG. 2 is a flow diagram showing production of a unitised high density composition from a concentrated milk fat composition and one or more milk powders.

FIG. 3 is a flow diagram showing production of a unitised high density composition from one or more milk powders, a high fat paste and a milk fat concentrate. The high fat paste and milk fat concentrate may be added sequentially or simultaneously to the powder or pre-mixed before addition to the powder.

### DETAILED DESCRIPTION OF THE INVENTION

The inventors have surprisingly determined that a concentrated milk fat composition may be produced by a method described above. The resulting concentrated milk fat composition is a water-in-oil emulsion comprising about 85 to about 99.5% by weight lipid and a moisture content of about 0.05 to about 15% by weight.

The concentrated milk fat composition may be processed to further reduce the moisture content or used as an ingredient in the production of other food compositions, particularly dairy powder compositions. The high fat paste concentrates produced by methods of the invention have greater efficacy as emulsifiers when recombined into liquid milk than either buttermilk powder or skim milk powder.

The inventors have also surprisingly found that powders that have a density less than or equal to 50% of the material density can be replaced with a powder/lipid blend of the same or similar composition that can be compressed to a density of about 50 or more or about 60 to about 85% or more of the material density. The material density of dairy powders, the density without any voids or entrapped air, can be calculated from the data of Buma (1965). For example, the material density, ρₘ is the inverse of the specific volume, vₘ of the mixture without any voids or entrapped gases.

$${ρ}_{m} = \frac{1}{{v}_{m}}$$

The specific volume of the mixture is the sum of the volumes of each component in the mixture which ignores the effect of any interactions between components that affect the density.

vₘ=Σᵢxᵢvᵢ

The specific volume of each component may be a function of temperature, although many of those for solid components are constant. Constant values are casein 0.71429 L/kg, whey 0.74074 L/kg (including both native & denatured), lactose 0.62854 L/kg (calculated from data of Buma, 1980), sucrose 0.62972 L/kg (from Rahman, 1995, page 197), and ash 0.34483 L/kg. The specific volumes of water and lipid are functions of temperature. For water the specific volume is given by the expression from Irvine & Liley (1984, page 22). The milk fat specific volume is calculated from the temperature, T in Celsius using the following equation.

$${v}_{fat} = \frac{1}{928.75 - 0.677803 T + 1.89394 \times {10}^{- 4} {T}^{2}}$$

The described unitised high density compositions, otherwise described as compacts or blocks, allow greater use of storage space, reduced freight costs due to reduced volumes, and reduced environmental impact due to reduced packaging needs. The inventors have found that the ratio of lipid to powder can be adjusted to provide commercially useful formulations, as shown in the examples below. The inventors have surprisingly found that in some embodiments the unitised high density compositions comprise of a structure that readily crumbles on application of appropriate force reverting to a powder.

### 1. DEFINITIONS

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

The term “material density” means the density of the material with no voids or spaces between or within particles in the material and no entrapped air or other gas.

The term “unitise” is intended to mean that a cohesive mixture described herein has been compacted into a discrete, single, free-standing unit. Thus, a unitised high density composition is a discrete, single, free-standing unit.

### 2. PRODUCTION OF CONCENTRATED MILK FAT COMPOSITIONS

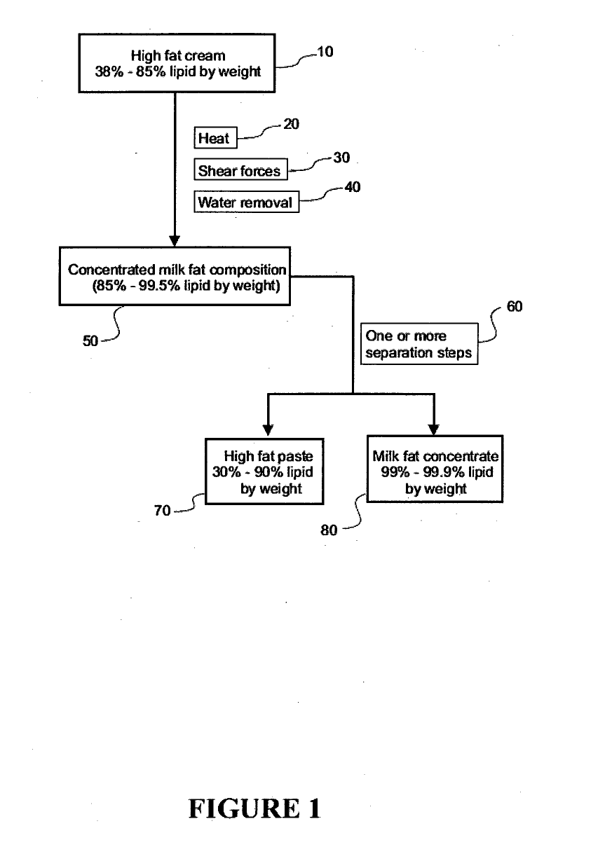

In a first aspect the invention relates to a method of producing a concentrated milk fat composition, as described above and as depicted generally in FIGS. 1 to 3. The concentrated milk fat composition (50) produced is a water-in-oil emulsion comprising about 85 to about 99.5% by weight lipid and optionally a moisture content of about 0.05 to about 15% by weight

The starting material is a high fat cream (10) that is an oil-in-water emulsion comprising about 38 to about 85% by weight lipid and optionally a moisture content of about 10 to about 62% by weight. High fat cream may be prepared from whole milk and low fat cream by known concentration methods including centrifugation. The high fat cream (10) will contain phospholipid that originates from the original dairy source but may optionally comprise an added source of phospholipid. Such sources of phospholipid powder include but are not limited to dairy phospholipid powders produced by fractionation of milk fat and optionally drying of the resulting fraction. Suitable phospholipid materials are described in published international patent application WO2009/020405 that is incorporated by reference.

The high fat cream (10) is initially heated (20) to a temperature higher than the melting point of the lipid present in the high fat cream, and lower than the smoke point of the lipid—i.e. about 32 to about 177° C.

After heating or concurrently with heating, the high fat cream (10) is subjected to shear forces (30) to convert (phase invert) the oil-in-water emulsion into a water-in-oil emulsion. The shear forces (30) may be imparted by known techniques suitable for processing liquid dairy products by phase inversion, including but not limited to comprising use of a homogeniser, a pump such as a centrifugal pump, a centripetal pump, or a positive displacement pump, direct steam injection, agitated thin film evaporation, wiped film evaporation, or a combination thereof. Shear rates of about 3000 to about 5000 s⁻¹ are typical in applications using a thin film evaporator. When using other equipment, the degree of shear imparted should be enough to phase invert the high fat cream but not enough to completely disrupt (homogenise) the lipid droplets in the high fat cream.

After or concurrently with application of shear forces, water from the high fat cream is removed. Water removal (40) is achieved by evaporation, absorption, supercritical extraction or liquid-liquid extraction. Processing choices for these steps are described herein and suitable evaporators, absorption media and solvents for liquid-liquid extraction and supercritical extraction are known in the art.

In one embodiment the method comprises heating (20) high fat cream (10), subjecting the high fat cream to shear forces (30) and removing water (40) from the high fat cream in one step. In this embodiment the step may be carried out using agitated thin film evaporation or wiped film evaporation.

In another embodiment the method comprises heating (20) high fat cream (10) in a first step, subjecting the high fat cream to shear forces (30) in a second step and removing water (40) from the high fat cream in a third step. These steps may be conducted in the stated order or concurrently. The second step or the third step or both the second and third steps optionally include heating the high fat cream, as described above. In this embodiment the first step, heating (20), comprises steam infusion, direct steam injection or contacting the high fat cream with a heat exchanger. In this embodiment the second step, imparting shear forces (30), comprises contacting the high fat cream with a device, such as a homogeniser, a pump such as a centrifugal pump, a centripetal pump or a positive displacement pump or an evaporator, that subjects the high fat cream to shear forces. In this embodiment the third step, water removal (40) comprises liquid-liquid extraction, absorption such as by addition of one or more desiccants, supercritical extraction, or evaporation with an evaporator such as falling film evaporation, flash evaporation, thin film evaporation, or wiped film evaporation. Liquid-liquid extraction includes but is not limited to extraction with one or more food grade solvents including but not limited to ethanol, hexane, acetone, carbon dioxide and dimethyl ether, or any combination of any two or more thereof. Useful desiccants include but are not limited to any food grade desiccant selected from a dietary fibre, modified starch, polydextrose, silica based powders or earths (including but not limited to diatomaceous earth and silica powders), activated carbon, inulin, and pectin, or any combination of any two or more thereof.

In an alternative embodiment the method comprises heating (20) high fat cream (10) and subjecting the high fat cream to shear forces (30) in a first step and removing water (40) from the high fat cream in a second step or concurrently with the first step. The second step optionally includes heating the high fat cream. In this embodiment the first step comprises direct steam injection sufficient to phase invert the high fat cream. In this embodiment the second step comprises liquid-liquid extraction, absorption such as by addition of one or more desiccants, supercritical extraction, or evaporation with an evaporator such as falling film evaporation, flash evaporation, thin film evaporation, or wiped film evaporation.

In yet another embodiment the method comprises heating (20) high fat cream (10) in a first step and subjecting the high fat cream to shear forces (30) and removing water (40) from the high fat cream in a second step or concurrently with the first step. The second step optionally includes heating the high fat cream. In this embodiment the first step comprises steam infusion, direct steam injection, or contacting the high fat cream with a heat exchanger. In this embodiment the second step comprises multiple stage flash evaporation, agitated thin film evaporation, or wiped film evaporation. In any of the embodiments described above, the concentrated milk fat composition may be subjected to drying, such as vacuum drying.

The concentrated milk fat compositions (50) produced by these methods and described above may be used in consumer products such as foods, food additives, baked goods, confectionary products including chocolate, gels, ice creams, snack bars, food bars, muesli bars, spreads, sauces, dips, dairy products including yoghurts and cheeses, drinks, drink additives, dairy and non-dairy drinks, milk, milk powders, dietary supplements, nutritional products, medical foods, enteral or parenteral feeding products, and meal replacement products. The concentrated milk fat compositions may also be used in animal feeds such as animal biscuits.

### 3. PRODUCTION OF MILK FAT CONCENTRATE AND HIGH FAT PASTE CONCENTRATE

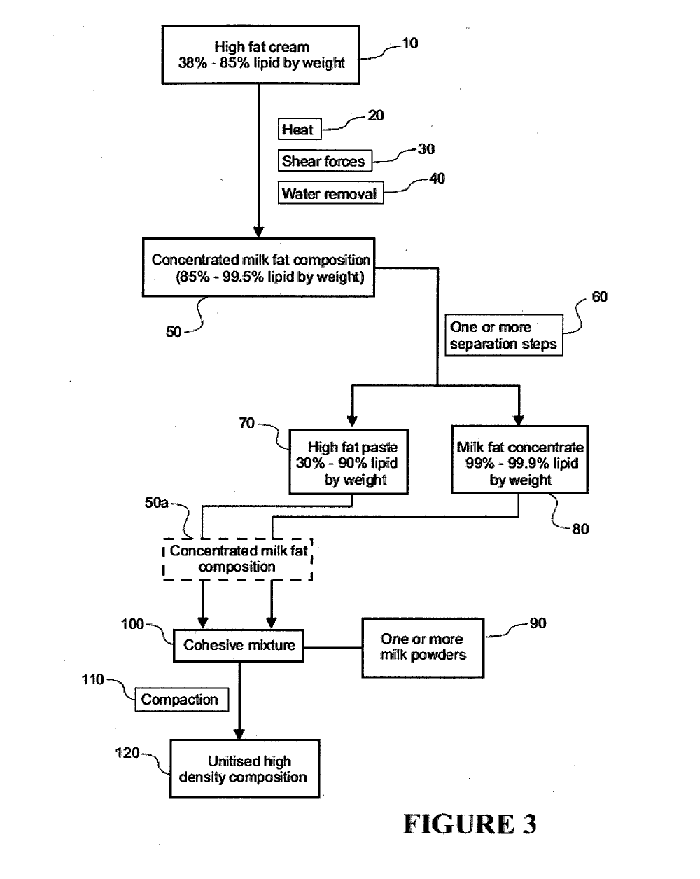

In another aspect, the invention relates to a method of producing a milk fat concentrate (80) and a high fat paste concentrate (70), as described above and as depicted generally in FIGS. 1 and 3.

A concentrated milk fat composition (50), such as a concentrated milk fat composition of the first aspect is provided at a temperature of about 17° C. to about 177° C. The concentrated milk fat composition will contain phospholipid that originates from the dairy source of high fat cream but may optionally comprise an added source of phospholipid. Such sources of phospholipid powder include but are not limited to dairy phospholipid powders produced by fractionation of milk fat and optionally drying of the resulting fraction. Suitable phospholipid materials are described in published international patent application WO2009/020405 that is incorporated by reference.

The concentrated milk fat composition (50) is subjected to one or more separation steps (60) selected from contacting the concentrated milk fat composition with a separator, liquid-liquid extraction, absorption such as by addition of one or more desiccants, supercritical extraction, or evaporation with an evaporator such as falling film evaporation, flash evaporation, thin film evaporation, or wiped film evaporation, or any combination of any two or more thereof. Useful solvents for liquid-liquid extraction and useful desiccants are described above. The one or more separation steps results in production of a high fat paste concentrate (70) and a milk fat concentrate (80). A suitable separator may be selected from the group including but not limited to a plate and frame filter, a leaf filter, a basket centrifuge, a decanter, a centrifugal separator, and a belt filter, or any combination of any two or more thereof. Such separators and methods for their operation are known in the art. In any of the embodiments described above, the high fat paste or milk fat concentrate may be subjected to drying, such as vacuum drying.

The high fat paste concentrate (70) and milk fat concentrate (80) produced by this method are described above. In one embodiment the high fat paste concentrate (70) is a composition comprising lipid solids suspended in oil, is a paste or is an oily cake. In one embodiment milk fat concentrate (80) is a water-in-oil emulsion. These compositions may be used as ingredients in other food and dairy products, including consumer products such as foods, food additives, baked goods, confectionary products including chocolate, gels, ice creams, snack bars, food bars, muesli bars, spreads, sauces, dips, dairy products including yoghurts and cheeses, drinks, drink additives, dairy and non-dairy drinks, milk, milk powders, dietary supplements, nutritional products, medical foods, enteral or parenteral feeding products, and meal replacement products. In some embodiments the milk fat concentrate meets the Codex description of Anhydrous Milk Fat and can be used as such. The concentrates may be used as phospholipid-rich ingredients, including as emulsifiers. The milk fat concentrate and the high fat paste concentrate may also be used in animal feeds such as animal biscuits.

### 4. HIGH DENSITY COMPOSITIONS

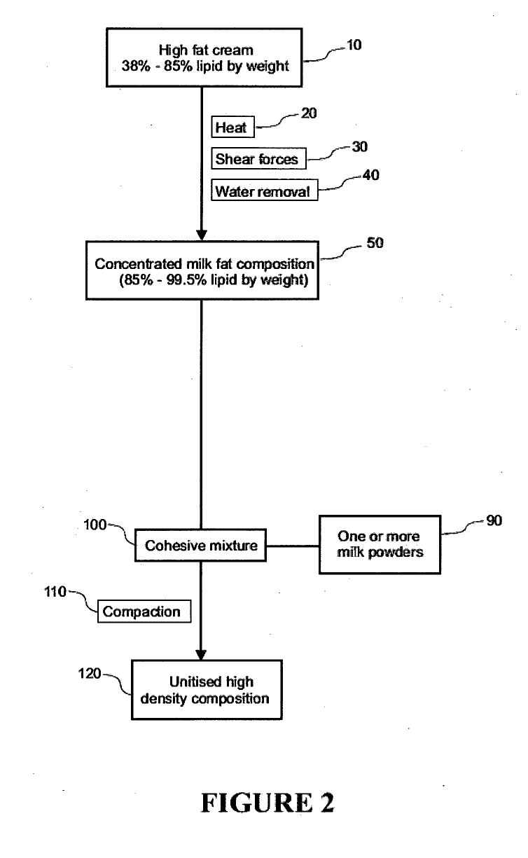

The invention also relates to a method of producing a unitised high density composition (120), as described above and as depicted generally in FIGS. 2 and 3. The unitised high density compositions produced according to the methods described herein are free standing, preferably free standing absent any external force, such as free standing blocks for example, and do not collapse under their own weight. These free standing blocks, or compacts, may be packaged, stored, shipped and then reconstituted and used, or used directly, to produce other products. In various embodiments 1, 2, 3, 4, 5, 6, 7, 8, 9, 10, 11, 12, 13, 14, 15, 16, 17, 18, 19 or 20 blocks or more are packaged together in one package. The unitised high density compositions comprise a structure that readily crumbles upon application of appropriate force reverting to a powder.

While FIGS. 2 and 3 depict the process starting with high fat cream, it should be understood that the compaction process depicted in FIGS. 2 and 3 may be conducted using any suitable milk fat composition to produce the cohesive mixture (100) including milk fat compositions that have been prepared, stored and/or shipped.

In one embodiment the method comprises providing a cohesive mixture (100) of a concentrated milk fat composition (50) and one or more milk powders (90) (FIG. 2). The amount of each is chosen to obtain a desired target composition while also not compromising the integrity of the unitised high density composition (120) produced by the compaction step (110).

In another embodiment the method comprises providing a cohesive mixture (100) of one or more milk powders (90) and a combination of a high fat paste (70) and a milk fat concentrate (80) (FIG. 3). In this embodiment the amount of each of a high fat paste (70) and a milk fat concentrate (80) is selected to produce a cohesive mixture of a desired composition. The amount of each component is chosen to obtain a desired target composition while also not compromising the integrity of the unitised high density composition produced by the compaction step (100). A high fat paste (70) and a milk fat concentrate (80) may be added sequentially or simultaneously to one or more milk powders (90) to form a cohesive mixture (100). Alternatively, a high fat paste (70) and a milk fat concentrate (80) may be mixed to form a concentrated milk fat composition (50a) that is then added to the one or more milk powders (90).

The milk fat composition (50, 50a) is a liquid or semi-liquid water-in-oil emulsion and comprises about 85% to about 99.95% by weight lipid and a moisture content of about 0.05 to about 15% by weight. Similarly, a high fat paste (70) and a milk fat concentrate (80) when added sequentially or simultaneously to one or more milk powders (90) to form a cohesive mixture (100) in combination comprise about 85% to about 99.95% by weight lipid and a moisture content of about 0.05 to about 15% by weight.

The milk fat composition (50, 50a), the high fat paste (70) and/or the milk fat concentrate (80) are optionally heated to a temperature of about 17 to about 177° C. before or while being mixed with one or more milk powders (90) to form a cohesive mixture (100), and then optionally cooled to the desired temperature for compaction (110). Properties of the concentrated milk fat compositions, high fat paste, milk fat concentrate and milk powders useful in the method are described above.

Blending to produce the cohesive mixture (100) may be carried out using any known blending equipment that is able to blend lipid (50, 50a, 70, 80) and milk powders (90) to form a homogenous mixture.

The mixture (100) is compacted (110) to produce a unitised high density composition (120) having a volume of at least about 50 cm³ and a density of at least about 50% or at least about 60% of the material density of the mixture. The pressure required to achieve the specified density may be determined by a skilled worker using known equipment having regard to that skill and the teaching of this specification.

In some embodiments mixing and compacting may be simultaneous (for example, extrusion). In other embodiments mixing and compacting may be sequential (for example, mixing, moulding and compressing in batches). In still other embodiments compaction may be carried out in multiple stages (for example, pre-compaction followed by compaction).

The compaction step (110) may be conducted batch-wise in a mould or similar, or continuously by extrusion, in one step or in multiple steps. Extrusion may be performed in any known extruder that is able to compact the cohesive mixture and extrude an extrudate having a cross-section suitable for packaging, storage and transportation of the unitised high density composition. After extrusion, the extrudate may then be cut into discrete pieces of a size suitable for packaging, storage and transportation of the unitised high density composition. Equally, batch moulding and compression may be performed in any known apparatus that is able to mould and compact the cohesive mixture to produce a unitised high density composition. After moulding and compression, the compact may then be removed from the mould for packaging, storage and transportation of the unitised high density composition. By way of non-limiting example, suitable pressures for use in a batch process comprising compacting the mixture in a mould may include pressures of about 0.05 to about 100 MPa, about 0.5 to about 100 MPa, about 0.05 to about 5 MPa, about 0.5 to about 5 MPa or about 1 to about 3 MPa.

The unitised high density composition (120) may be formed before, during or after the compaction step into any readily-stackable three-dimensional shape, including but not limited to cylinders, hexahedra such as cuboids and cubes, and tetrahedra. Readily-stackable three-dimensional shapes include those having a cross-section that is square, rectangular, pentagonal, hexagonal, octagonal, or similar. The shape of a mould or an extrusion die may be chosen with regard to the processing equipment available, the packaging format available, and the intended storage and/or transportation choice. In any of the embodiments described above, the unitised high density composition may be subjected to drying, such as vacuum drying.

The unitised high density composition (120) may be packaged in any suitable way, such as vacuum packaged. Packaging materials may be chosen for their oxygen barrier properties, opacity, thermal insulation or combinations thereof. In various embodiments, packaging is conducted in an inert atmosphere. In one embodiment a plurality of the packaged compositions are loaded onto a pallet or into a shipping container.

Further properties of the unitised high density composition are described above and examples of suitable unitised high density compositions are presented in the examples below. The unitised high density compositions are particularly suited to shipping and storage and may be readily reconstituted for use in dairy or food products, including consumer products such as foods, food additives, baked goods, confectionary products including chocolate, gels, ice creams, snack bars, food bars, muesli bars, spreads, sauces, dips, dairy products including UHT milks, yoghurts and cheeses, drinks, drink additives, dairy and non-dairy drinks, milk, milk powders, dietary supplements, nutritional products, medical foods, enteral or parenteral feeding products, and meal replacement products. The unitised high density composition can be reconstituted in water and then dried into whole milk powder. Alternatively, the reconstituted product can be separated into cream and skim milk. The skim milk may be processed into milk protein concentrates, casein products, whey products, or dried to produce skim milk powder.

Various aspects of the invention will now be illustrated in non-limiting ways by reference to the following examples.

### EXAMPLES

### Example 1

### Production of a Concentrated Milk Fat Composition by Thin Film Evaporation

Whole milk (Fonterra Co-operative Group Limited, New Zealand) was pasteurised (75° C. for 15 s) and centrifuged to separate the milk into skim milk and cream of about 40% fat by weight. The cream was further separated with a high fat cream centrifugal separator (Westfalia™ MSD50, GEA) to produce a high fat cream of about 80% fat by weight.

The high fat cream was then directed to a horizontal co-current agitated thin film evaporator (ATFE) with heated wall surface area of 5.25 sq. ft., rotor diameter 30 cm and gap between blade and heated wall 3 mm (Artisan Industries, Inc, USA). The ATFE was fitted with a preheating system, a condenser and a vacuum pump. The cream at a flow rate of 130 kg/h was heated to a temperature of 120° C. by direct steam injection and held for a residence time of 4 s, set by the volume of the transfer pipe to the evaporator. The ATFE was run at an absolute pressure of 22 kPa, heating jacket pressure of 250 kPa (absolute) and rotor speed of 700 rpm. In this operation the cream was inverted from an oil-in-water emulsion to a water-in-oil emulsion. The resulting fat stream was then passed to a second horizontal counter-current ATFE (Artisan Industries, Inc, USA), rotor diameter 15 cm, 3 mm gap, run at a pressure of 8 kPa (without any heating of the 1 sq. ft. jacket) and rotor speed of 1200 rpm. In these ATFE systems water was removed to produce a concentrated milk fat composition having a lipid concentration of 97.3% by weight and a moisture content of 0.25%. Moisture content was determined by Karl Fischer titration using a Metrohm™ Model 787 volumetric titrator (Metrohm Ltd, Switzerland). The concentrated milk fat composition was packed off in drums under a nitrogen atmosphere.

### Example 2

### Production of Concentrated Milk Fat Compositions

High fat cream (HFC) of about 80% fat by weight was produced according to Example 1. The HFC was treated according to one of the four following methods and inverted from an oil-in-water emulsion to a water-in-oil emulsion to form a concentrated milk fat composition (CMFC).

### Example 2A

HFC at 65° C. was pumped by positive lobe pump through a steam heated plate heat exchanger (Pasilac, Denmark) to 101° C. and stored in a static vessel. The HFC remained as an “oil in water” emulsion. The HFC was then directed to a horizontal co-current agitated thin film evaporator (ATFE) with heated wall surface area of 5.25 sq. ft., rotor diameter 30 cm and gap between blade and heated wall 3 mm (Artisan Industries, Inc, USA). The ATFE was fitted with a preheating system, a condenser and a vacuum pump. The HFC at a flow rate of 120 kg/h was heated to a temperature of 120° C. by direct steam injection and held for a residence time of 4 s, set by the volume of the transfer pipe to the evaporator (before flashing into the ATFE). The ATFE was run at an absolute pressure of 20.5 kPa, heating jacket pressure of 250 kPa (absolute) and rotor speed of 712 rpm. The resulting CMFC was collected.

### Example 2B

HFC at 65° C. was pumped by positive lobe pump through a steam heated plate heat exchanger (Pasilac, Denmark) to 101° C. and stored in a static vessel. The HFC remained as an “oil in water” emulsion. The HFC was transferred to the balance tank of a 2-stage homogeniser (Rannie, Denmark) and phase inverted at 130 bar using a single homogenising stage. The resulting “water in oil” emulsion was then directed to an ATFE as described in Example 2A. The HFC was transferred to the ATFE and heated as described in Example 2A. The ATFE was run at an absolute pressure of 22 kPa, heating jacket pressure of 250 kPa (absolute) and rotor speed of 712 rpm. The resulting CMFC was collected.

### Example 2C

HFC at 65° C. was pumped by positive lobe pump through a low velocity steam infuser (Fonterra Co-operative Group Limited, New Zealand) and heated to 101.6° C. The HFC (oil-in-water emulsion) was flash cooled under atmospheric conditions in the cyclone of a Vacreator Model 7 (Protech Engineering Limited, New Zealand) and collected by gravity in buckets. The HFC was then directed to an ATFE as described in Example 2A. The HFC was transferred to the ATFE, heated and the ATFE run as described in Example 2B. The resulting CMFC was collected.

### Example 2D

HFC at 65° C. was directed to an ATFE as described in Example 2A. The HFC was transferred to the ATFE and heated as described in Example 2A. The ATFE was run at an absolute pressure of 20.5 kPa, heating jacket pressure of 253 kPa (absolute) and rotor speed of 176 rpm. The resulting CMFC was collected.

Results:

The CMFC produced were analysed and the results are shown in the following Table 1. The moisture, fat, protein and lactose concentrations of these compositions were determined by the methods described in the examples below.

TABLE 1
Analysis of CMFC produced in Example 2

| | | Fat | Water | Protein | Lactose |
|---|---|---|---|---|---|
| Example | Material | % w/w | % w/w | % w/w | % w/w |
| | Cream | 41.12 | ND | 1.98 | 2.88 |
| 2A | HFC | 79.84 | 18.70 | 0.77 | 0.58 |
| 2A | CMFC | 98.34 | 2.95 | 0.90 | 0.76 |
| 2B | HFC | 79.84 | 18.70 | 0.77 | 0.58 |
| 2B | CMFC | 97.99 | 0.32 | 0.18 | 1.83 |
| 2C | HFC | 83.00 | 15.40 | 0.63 | 0.52 |
| 2C | CMFC | 96.98 | 0.48 | 0.84 | 2.18 |
| 2D | HFC | 79.78 | 19.00 | 0.74 | 0.46 |
| 2D | CMFC | 98.69 | 0.93 | 0.96 | 0.35 |

ND—Not determined.

### Example 3

### Addition of Phospholipid

Cream that had been washed and had a phospholipids enriched powder reconstituted into it was separated to form a High fat cream (HFC). This HFC was heated directly using a high velocity steam infusion device, and was then flash evaporated in a rotary thin film evaporator to form a fat continuous concentrated milk fat composition (CMFC) with increased phospholipids when compared to a control CMFC.

### 1. Materials

Whole milk sourced from Fonterra Co-operative Group Limited, New Zealand, was pasteurised (75° C. for 15 s) and centrifuged to separate the milk into skim milk and cream of 41.2% fat. The cream was diluted with water at a ratio of 1:10 and separated again to form a washed cream. Beta-serum powder (BSP) (Fonterra Co-operative Group Limited, New Zealand) was reconstituted into the cream which was further separated at 65° C. with a high fat cream centrifugal separator to a high fat cream of 76.7% fat and 2.5% solids-not-fat. A control cream which had not been washed nor had BSP added was also processed.

### 2. Method

High fat cream (HFC) at 65° C. was directed to a horizontal co-current agitated thin film evaporator (ATFE) with heated wall surface area of 5.25 sq. ft., rotor diameter 30 cm and gap between blade and heated wall 3 mm (Artisan Industries, Inc, USA). The ATFE was fitted with a preheating system, a condenser and a vacuum pump. The cream at a flow rate of 120 kg/h was heated to a temperature of 120° C. by direct steam injection and held for a residence time of 4 s, set by the volume of the transfer pipe to the evaporator. The ATFE was run at an absolute pressure of 20.0 kPa, heating jacket pressure of 252 kPa (absolute) and rotor speed of 712 rpm. In this operation the cream was inverted from an oil-in-water emulsion to a water-in-oil emulsion to form concentrated milk fat composition (CMFC).

### 3. Method—Measurement

The following methods of analysis were used to determine the composition of the cream, HFC and CMFC and the results are shown in Table 2 below. Fat Gravimetric (Roese Gottlieb): International Dairy Federation (2008), Cream—Determination of fat content—Gravimetric method (reference method), IDF Standard 16, 4th edition, International Dairy Federation, Brussels, Belgium. Fat Moisture: Automated titration equipment used according to IDF Standard 23A:1988 Milkfat Products, Water Content (Karl Fischer Method). Protein: International Dairy Federation (2001), Milk—Determination of nitrogen content—Part 1: Kjeldahl Method, IDF Standard20-1, International Dairy Federation, Brussels, Belgium. Lactose: SAN™ autoanalyzer system, SKALAR, Netherlands. Phospholipid: Lipid from the fat test was digested with nitric acid/hydrochloric acid and the resulting solution analysed for phosphorus by ICP (inductively coupled plasma) atomic emission spectroscopy.

### 4. Results

TABLE 2
Measurement of phospholipid levels in cream, HFC and CMFC

| | | Fat | Water | Protein | Lactose | Phospholipid |
|---|---|---|---|---|---|---|
| Example | Material | % | % | % | % | mg/100 g fat |
| Control | Cream | 38.8 | ND | 2.05 | 3.05 | 436 |
| Control | HFC | 78.4 | 19.72 | 0.79 | 0.99 | 319 |
| Control | CMFC | 98.21 | 0.12 | 0.86 | 0.93 | 316 |
| Added Phospholipid | Cream | 25.6 | ND | 2.81 | 3.89 | 3000 |
| Added Phospholipid | HFC | 76.7 | 22.36 | 0.96 | 1.51 | 518 |
| Added Phospholipid | CMFC | 98.03 | 0.15 | 1.03 | 0.95 | 428 |

ND—not determined.

### Example 4

### Production of a High Density Composition

A batch blender with rotating blades was used for the formation of a cohesive powder. The lid of the blender was fitted with a dropper pipe for addition of the concentrated milk fat composition of Example 1. The blender was filled with 50 kg of skim milk powder (SMP) from a drying plant. The drummed concentrated milk fat composition to be added was melted in a hot tub to a temperature of 50° C. 18.0 kg was transferred to a pressure vessel and held under a nitrogen atmosphere (2.0 bar gauge pressure)). The quantities of SMP and concentrated milk fat composition were chosen to produce a product with the composition of a standard whole milk powder. The blender was started and then the liquid fat was added at a rate of 0.36 kg/s for 50 s, followed by blending for a further 20 s. The resulting product had the consistency of a cohesive powder and contained all of the milk solids required for manufacturing a milk of standard milk composition. Samples (A) were taken and tested for solubility index by the industry standard test (American Dried Milk Institute (ADMI) Solubility Index (SI) test, IDF Standard 129A, International Dairy Federation, Brussels, Belgium, 1998) (see Table 3 below).

The product was then discharged to a container and transferred to a press. 20 kg of the product was filled into a mould with dimensions of horizontal cross-section of 333 mm×387 mm and height of 500 mm. The product was pressed to a height of 193 mm, giving a final volume of 24.87 litres and packing density of 1.01 kg/L, which required a hydraulic pressure of about 700 bar (295 kN cylinder, internal diameter 73 mm; Enerpac, www.enerpac.com). The powder block was disengaged from the mould and then vacuum wrapped according to commercial practice. The material density of the block was calculated to be 1.3 kg/L.

### Example 5

### Storage, Reconstitution and Use

Blocks were stored for 15 weeks to simulate the time taken for testing and shipment of product and then transferred to a recombining plant. The plant consisted of a reconstitution vessel (nominal 150 L) fitted with a variable speed agitator (rotor diameter 160 mm) run at a speed to induce a vortex in the mixture to keep material in suspension. A block of Example 4 was taken, the vacuum on the package was released and the block was broken up into pieces of approximately 3 kg. A sub-sample (1 kg) (Sample B) of material was taken, further broken up and tested for SI. The results are shown in Table 3 below in Row B. Both the initial and “at time of reconstitution” SI results were very good. 86 kg of water at 45° C. was weighed into the reconstitution vessel and 13.4 kg of the block was added piecewise. The pieces disintegrated rapidly and dispersed when added to warm water which was accomplished within 2.5 min. After 20 minutes of hydration the material was passed to a homogeniser and treated at a temperature of 60° C. with a first stage pressure of 100 bar and a second stage pressure of 30 bar, cooled to 7° C., passed through a filter (cylinder 35 mm D×255 mm length, apertures 3 mm D) and dispatched to a holding tank. The concentration was tested with a MilkoScan™ FT2 standardising device (Foss Electric, Denmark), and adjusted to 12.5% total solids by addition of portable water.

TABLE 3
Solubility Index of samples (A) and (B)

| Sample (Time) | ADMI SI (mL) |
|---|---|
| A (Initial) | 0.12, 0.1 |
| B (At time of reconstitution) | 0.05 |

After reconstitution and homogenisation was completed the filter was inspected and had a minimal quantity of particulate residue, which is in accordance with the SI results in Table 3 above.

Reconstituted material was drawn from the holding tank and treated at 120 L/h in a UHT plant, heated indirectly with hot water. The milk was heated, held at 140° C. for 5 s, cooled to 75° C., homogenised at pressures of first stage 170 bar, second stage 30 bar (total 200 bar), cooled to 20° C. and packed aseptically in sterile glass bottles (250 mL) with screw tops. The UHT milk was evaluated for aroma and flavour at ambient temperature by a trained sensory panel. The appearance and sensory profile were acceptably similar to control UHT products made from conventional milk ingredients.

### Example 6

### Production of a Milk Fat Concentrate and a High Fat Paste Concentrate

Whole milk was pasteurised (75° C. for 15 s) and centrifuged to separate the milk into skim milk and cream of 40.8% fat. The cream was further separated with a high fat cream centrifugal separator to a high fat cream of 79.5% fat and 2.5% solids-not-fat. The high fat cream was then directed to an agitated thin film evaporator (ATFE), rotor diameter 30 cm, run under vacuum. The high fat cream, at a flow rate of 130 kg/h, was heated to a temperature of 130° C. by direct steam injection and held for a residence time of 4 s, set by the volume of the transfer pipe to the ATFE. The ATFE was run at an absolute pressure of 22 kPa and rotor speed of 700 rpm. In this operation the high fat cream was inverted from an oil-in-water emulsion to a water-in-oil emulsion. This was then passed to a second ATFE, rotor diameter 15 cm, run at a pressure of 7.6 kPa and rotor speed of 1200 rpm. In these steps water was removed to give a concentrated milk fat composition of 0.35% moisture (by Butter Oven moisture, Standard IDF80-1 (ISO 03727), International Dairy Federation (2001), Belgium). The concentrated milk fat composition was stored in a temperature-controlled agitated tank and cooled to 45° C. under a nitrogen atmosphere.

A plate and frame membrane filter press (Durco Quadra Press, Flowserve Texas, USA) was used to separate a dry milk fat stream from the concentrated milk fat composition. 100 kg of phase-inverted high fat cream was pumped by a positive displacement lobe pump into the press at an initial flow rate of 300 kg/h and a temperature of 45° C. The press was filled until flooded at which point the filtrate, a milk fat concentrate, was run off through the drainage ports of the press into a storage vessel from which it was filled into opaque 20 litre plastic pails. A fill pressure of 4 bar on the press was achieved at which point the filling was stopped and the press secured for pneumatic compression of the retained filter cake. Regulated compressed air was run into the membrane plates to a maximum pressure of 6 bar delivered in increasing 1 bar increments over 10 minutes. The filter cake was held under a pressure of 6 bar for a further 20 minutes after which the pressure was released to atmospheric conditions. During the compression of the filter cake, a milk fat concentrate was run off. A total of 87.5 kg was collected. The press was opened and 12.5 kg of cake was removed as a high fat paste concentrate.

The moisture, fat, protein and lactose concentrations of these concentrates were determined by the following methods. Fat Gravimetric (Roese Gottlieb), Protein, Lactose and Phospholipid: As for Example 3. Fat (Butter) Moisture/Total Solids: International Dairy Federation (2001), Standard IDF80-1 (ISO 03727). First edn 2001-12-15. International Dairy Federation, Brussels, Belgium.

The composition of the milk fat concentrate comprising the filtered milk fat was 99.8% fat (Roese Gottlieb method with salt added), 0.18% moisture (Butter Oven Moisture method), and 6 mg/kg protein/fat.

The composition of the high fat paste concentrate comprising the filter cake was 77.7% fat, of which 2.19% was phospholipid, 0.95% moisture, 8.49% protein (Kjeldahl Nitrogen on semi/solid), and 12.2% lactose as monohydrate.

The milk fat concentrate obtained from this process complies with the Codex description of Anhydrous Milk Fat and can be used as such.

### Example 7

### Production a Milk Fat Concentrate and a High Fat Paste Concentrate by Centrifugal Separation

Three concentrated milk fat composition (CMFC) samples were separated in a centrifugal separator to form a milk fat concentrate (MFC) and a high fat paste concentrate (HFPC).

### 1. Materials

Whole milk sourced from Fonterra Co-operative Group Limited, New Zealand, was pasteurised (75° C. for 15 s) and centrifuged to separate the milk into skim milk and cream of 41.2% fat. The cream was diluted with water at a ratio of 1:10 and separated again to form a washed cream. The washed cream was split and to one portion beta-serum powder (BSP, Fonterra Co-operative Group Limited, New Zealand) was reconstituted into the cream which was further separated at 65° C. with a high fat cream centrifugal separator to a high fat cream of 76.7% fat and 2.5% solids-not-fat. The remaining washed cream was processed with no further modification. A control cream which had not been washed nor had BSP added was also processed.

### 2. Method

High fat cream (HFC) at 65° C. was directed to a horizontal co-current agitated thin film evaporator (ATFE) with heated wall surface area of 5.25 sq. ft., rotor diameter 30 cm and gap between blade and heated wall 3 mm (Artisan Industries, Inc, USA). The ATFE was fitted with a preheating system, a condenser and a vacuum pump. The cream at a flow rate of 120 kg/h was heated to a temperature of 120° C. by direct steam injection and held for a residence time of 4 s, set by the volume of the transfer pipe to the evaporator. The ATFE was run at an absolute pressure of 20.0 kPa, heating jacket pressure of 252 kPa (absolute) and rotor speed of 712 rpm. In this operation the cream was inverted from an oil-in-water emulsion to a water-in-oil emulsion to form concentrated milk fat composition (CMFC).

The CMFC products were pumped at a flow rate of 300 kg/h to a centrifugal separator (Westfalia KNA3, GEA) at a temperature of 45° C. and split into two phases. A lighter phase, MFC, was removed from the separator by a centripetal pump operating under a back pressure of 3 bar gauge and packed off in opaque plastic pails. The heavy phase, HFPC, was collected in the desludge zone of the separator bowl and 2.5 kg of this paste was ejected into a cyclone every 5 minutes and packed off in opaque plastic pails.

### 3. Method—Measurement

The methods of analysis described in Examples 3 and 6 were used to determine the composition of the cream, HFC and CMFC and the results are shown in Table 4 below.

### 4. Results

TABLE 4
Analysis of cream, HFC and CMFC

| | | Fat | Water | Protein | Lactose | Phospholipid |
|---|---|---|---|---|---|---|
| Example | Material | % | % | % | % | mg/100 g fat |
| Control | Cream | 38.8 | ND | 2.05 | 3.05 | 436 |
| Control | HFC | 78.4 | 19.72 | 0.79 | 0.99 | 319 |
| Control | CMFC | 98.21 | 0.12 | 0.86 | 0.93 | 316 |
| Control | MFC | 99.94 | 0.06 | 0 | 0 | ND |
| Control | HFPC | 88.5 | 0.53 | 3.96 | 6.26 | ND |
| Washed | Cream | 32.9 | ND | 0.26 | 0 | 284 |
| Washed | HFC | 81.8 | 19.18 | 0.36 | 0 | 241 |
| Washed | CMFC | 99.55 | 0.06 | 0.45 | 0 | 240 |
| Washed | MFC | 99.95 | 0.05 | 0 | 0 | ND |
| Washed | HFPC | 97.8 | 0.24 | 1.25 | 0.22 | ND |
| Added Phospholipid | Cream | 25.6 | ND | 2.81 | 3.89 | 3000 |
| Added Phospholipid | HFC | 76.7 | 22.36 | 0.96 | 1.51 | 518 |
| Added Phospholipid | CMFC | 98.03 | 0.15 | 1.03 | 0.95 | 428 |
| Added Phospholipid | MFC | 99.92 | 0.08 | 0 | 0 | ND |
| Added Phospholipid | HFPC | 88.4 | 1.23 | 3.59 | 5.41 | ND |

ND—not determined.

### Example 8

### Production of Recombined Cream

High fat paste concentrate (HFPC) and other sources of dairy milk solids (all from Fonterra Co-operative Group Limited, New Zealand) at various ratios were reconstituted and homogenised with milk fat concentrate to form a cream. The fat globule size distribution of the resulting cream was measured.

### 1. Materials

Milk fat concentrate was separated from molten concentrated milk fat composition (CMFC) in a plate and frame filter press. The MFC was heated to 70° C. to erase the crystal memory before being cooled to the required blending temperature. The other milk solids used were spray dried skim milk powder, spray dried butter milk powder, and four high fat paste concentrates designated HFPC 100, HFPC 110, HFPC 120, HFPC 130. The numbering of the HFPCs refers to the temperature in ° C. to which the high fat cream was heated during the heat step in the production of the concentrated milk fat composition from which the HFPC was separated. All HFPCs were prepared by plate and frame separation of CMFC.

### 2. Methods

A weighed amount of milk solids was added to a weighed amount of hot water and mixed to form a solution using a Lighten propeller mixer. The required amount of milk fat concentrate to form a 25% fat solution was added and mixed into the solution using a Maelstrom IPB40-35-50-11ss mixer (Maelstrom Advanced Process Technologies Limited, England) with the mixer head located in the water phase. The mixer was switched on and run for 300 seconds at 1500 rpm. The resulting mixture was poured into sample containers and placed into a 5° C. refrigerator. Creams with a range of protein to fat ratios were prepared. Samples were examined by Malvern Mastersizer 2000 (Malvern Instruments Limited, Worcestershire, England) to assess the relative size and distribution of any fat globules present.

### 3. Results

The mixtures summarised in Table 5 below formed creams of varying stability. Creams where the milk solids non fat portion of the composition was sourced from butter milk powder or skim milk powder were unstable i.e. creamed readily or did not form a cream that could be measured by the Malvern apparatus until the protein to fat ratio was at least 0.007:1. Surprisingly creams where the milk solids non fat portion of the composition was sourced from a high fat paste concentrate with a protein:fat ratio of 0.004:1 had better stability than butter milk powder with a protein:fat ratio of 0.007:1 and skim milk powder with a protein:fat ratio of 0.0085:1—see Table 5 where creams with a smaller d(0.9) size were more stable.

TABLE 5
Milk fat globule size and distribution of reconstituted creams

| | | | | | Volume | Surface |
|---|---|---|---|---|---|---|
| | | | | | Weighted | Weighted |
| | Protein:Fat | d(0.1) | d(0.5) | d(0.9) | Mean | Mean |
| Milk Solids | Ratio | μm | μm | μm | μm | μm |
| HFPC 100 | 0.003:1 | 3.7 | 6.6 | 11.7 | 7.2 | 6.0 |
| HFPC 110 | 0.003:1 | 4.7 | 8.8 | 16.3 | 9.8 | 7.9 |
| HFPC 120 | 0.003:1 | 4.9 | 9.4 | 19.7 | 13.0 | 8.4 |
| HFPC 100 | 0.004:1 | 3.1 | 5.6 | 10.1 | 6.2 | 4.8 |
| HFPC 110 | 0.004:1 | 3.2 | 5.7 | 10.2 | 6.3 | 4.9 |
| HFPC 120 | 0.004:1 | 3.6 | 7.0 | 13.6 | 8.1 | 5.7 |
| HFPC 130 | 0.004:1 | 5.3 | 11.6 | 27.0 | 15.4 | 9.9 |
| HFPC 100 | 0.0055:1 | 2.4 | 3.6 | 5.5 | 3.8 | 3.4 |
| HFPC 110 | 0.0055:1 | 2.7 | 4.3 | 7.3 | 4.7 | 4.1 |
| HFPC 120 | 0.0055:1 | 2.7 | 4.2 | 6.6 | 4.5 | 4.0 |
| HFPC 130 | 0.0055:1 | 3.0 | 5.4 | 9.6 | 5.9 | 4.8 |
| HFPC 130 | 0.007:1 | 2.8 | 4.9 | 8.7 | 5.4 | 4.4 |
| Butter Milk Powder | 0.007:1 | 3.0 | 8.8 | 91.1 | 30.0 | 6.4 |
| Skim Milk Powder | 0.007:1 | 4.6 | 53.6 | 263.5 | 98.3 | 13.8 |
| Buffer Milk Powder | 0.0085:1 | 3.3 | 8.8 | 37.6 | 17.3 | 6.4 |
| Skim Milk Powder | 0.0085:1 | 3.5 | 9.4 | 50.2 | 21.6 | 27.5 |

### Example 9

### Production of High Density Compositions and Density Measurement

Five spray-dried powders were mixed with anhydrous milk fat (AMF), compacted and the density measured. The results are shown in Table 6 below.

### 1. Materials

The powders were regular skim milk powder (SMP), instant SMP (ISMP—agglomerated SMP), regular whole milk powder (WMP), instant WMP (IWMP—agglomerated and lecithinated WMP) and high fat milk protein concentrate. All powders and the AMF were obtained from Fonterra Co-operative Group Limited (New Zealand). The AMF was kept at 40° C. prior to addition. The powder samples were held at ambient temperature.

### 2. Method—Mixing

A weighed amount of powder was poured into a beaker of known volume and the powder level measured with calipers. A weighed amount of AMF was poured into the middle of the powder. The powder and the AMF were mixed gently with a spatula until the mixture appeared uniform and then the powder/AMF mixture level was measured with calipers.

### 3. Method—Compaction

The powder/AMF mixtures were compacted by placing 1 teaspoon of sample into a glass cup of predetermined size and weight, tamping down the sample with a plunger, repeating these steps until the glass cup was completely full, leveling the sample off with a metal spatula.

The filled cup was weighed and the density of the compacted mixture was calculated by dividing the mass of powder by the volume of the glass cup (48 ml). The force exerted during tamping was measured as 50 to 100 N and the pressure at the plunger surface determined to be 70 to 140 kPa.

### 4. Results

TABLE 6
Densities of the compacts.

| Powder to | Density (g/mL)* | | | | | Material Density (g/mL)* | |
|---|---|---|---|---|---|---|---|
| AMF | | | | | HF | | WMP/IWMP/HF |
| Ratio | ISMP | SMP | WMP | IWMP | MPC | ISMP/SMP | MPC |
| 60:40 | 0.89 | 1.06 | 1.01 | 0.97 | 0.96 | 1.19 | 1.11 |
| 70:30 | 0.72 | 0.94 | 0.86 | 0.78 | 0.89 | 1.26 | 1.15 |
| 75:25 | 0.69 | 0.86 | 0.84 | 0.72 | 0.81 | 1.29 | 1.17 |
| 80:20 | 0.64 | 0.80 | 0.74 | 0.70 | 0.75 | 1.33 | 1.20 |
| 85:15 | 0.58 | 0.75 | 0.69 | 0.64 | 0.71 | 1.37 | 1.22 |
| 100:0 | 0.53 | 0.70 | 0.61 | 0.56 | 0.63 | 1.50 | 1.30 |
| Bulk | 0.52 | 0.69 | 0.56 | 0.50 | 0.59 | — | — |
| density^{#} | | | | | | | |

*Results in italics indicate that excess AMF solidified on top of the powder.
^{#}Bulk density of powder alone assessed after 100 taps without compaction.

All mixtures packed down into a firm block that crumbled into a powder when touched, except that 100:0 powder that could not form a free-standing block and collapsed under its own weight. The SMP and ISMP packed mixtures were more delicate than the WMP, IWMP and HF MPC packed mixtures.

The AMF appeared to be entirely absorbed by the powder at a powder/AMF ratio of 70:30.

The 60:40 mixtures appeared to be over-loaded with fat and were slightly “oily” in appearance. The samples with other ratios were all ‘powder-like’. Of the 60:40 mixtures, the SMP mixture was the most “oily” in appearance and had a putty-like texture that was malleable and able to be formed into blocks.

Both of the mixtures produced from regular powders (SMP and WMP) appeared to be more cohesive or oily than the mixtures from their equivalent instant powders (ISMP and IWMP).

### Example 10

### Production of UHT Milk

Skim milk powder (SMP) (Fonterra Co-operative Group Limited) with d(0.5) of 450-800 microns was mixed with a concentrated milk fat composition (CMFC) of Example 2A to produce a mixture with a composition equivalent to that of whole milk powder (WMP). The mixture was compacted to form 25 kg unitised high density compositions meeting whole milk powder specifications (UHDC-WMP), which were vacuum packaged, placed into corrugated cardboard cartons and stacked on a pallet. The palletised UHDC-WMP was shipped to a UHT (ultra high temperature) sterilisation plant. Elapsed time between manufacture of compacts and production of UHT milk was 8 weeks. The UHDC-WMP was reconstituted and processed into UHT milk using a standard commercial process. The UHT treated milk was analysed by an experienced laboratory and found to exhibit typical physical and chemical properties for commercial UHT milk.

### 1. Method—Blending

The SMP and CMFC were batch blended using a 60 litre mechanical mixer. Each batch produced about 65 kg of mixture with a target of 27% CMFC. The SMP was added to the blender at ambient temperature and mixed while the CMFC was added at about 45° C. Each batch was blended for 120 seconds to ensure that the mixture was homogenous. The chemical composition of the mixture was analysed to ensure that it met the WMP specification shown in Table 7.

TABLE 7
WMP specification

| | Protein (w/w %) | Fat | Moisture | |
|---|---|---|---|---|
| Test | (N × 6.38) | (w/w %) | (w/w %) | Protein:SNF |
| Min Limit | 24.1 | 26 | — | 34.00 |
| Max Limit | 27.6 | 28 | 3.5 | — |

### 2. Method—Compaction, Packing and Transport

The mixture was compacted in 25 kg batches using a custom built hydraulic press. For each batch 25 kg of the mixture was weighed out, placed inside the press chamber and leveled out. The mixture was pressed between two platens from above and below (i.e. multi-directional compression) simultaneously. Each compact was removed from the press and placed in a plastic liner and vacuum packaged. The vacuum packaged compacts were placed in cardboard cartons and stored at ambient while the product was demonstrated as food safe. 30 compacts were stacked onto a pallet and dispatched to a UHT plant as a consignment of 750 kg which occupied 0.728 m³, i.e. a unit density of 1030 kg/m³. The material density of the compacts was calculated to be 1300 kg/m³.

### 3. Method—UHT Production

UHT milk was prepared according to industry standard techniques.

### 4. Results

Samples of UHT packs were evaluated by two laboratories highly experienced in evaluating UHT products; both physical properties and the sensory profile were regarded as acceptable, demonstrating the utility of the compressed product in commercial trade.

### Example 11

### Production of Yoghurt

UHDC-WMP compacts were prepared and packed as in Example 10. The compacts were recombined to milk and used to produce yoghurts at a pilot scale. The yoghurts were analysed by an experienced laboratory and deemed to exhibit typical physical and chemical properties for commercial yoghurt. The sensory profile of the yoghurts was also assessed by an experienced tasting panel and was regarded as acceptable.

### 1. Method—Yoghurt Production

The UHDC-WMP compacts were mechanically broken down to resemble a ‘crumb’. Approximately 4.5 kg of ‘crumb’ was combined with approximately 4 kg of skim milk powder and approximately 32 kg of water at 50-55° C. The mixture was agitated for approximately 30 minutes before being heated to 60° C. The mixture was then homogenised using a homogeniser (Rannie) and heat treated at 95° C. for 8 minutes. The batch was then cooled to 42° C. prior to inoculation (Chr Hansen YF-L702 culture). 90×100 ml potties were filled with the inoculated mixture, incubated at 42° C. until they reached pH 4.6 (approximately 4.5 h) and placed into storage at 4° C. The remainder of the inoculated mixture was incubated in bulk at 42° C. until it reached pH 4.6 (approximately 5 h), stirred gently to break the gel and chilled to 20° C. using a plate heat exchanger. The mixture was then smoothed using a back pressure valve before being packed into 90×100 ml potties and placed into storage at 4° C.

### 2. Results

The yoghurts were analysed for physical and chemical properties by an experienced laboratory and were found to be of an acceptable standard for commercial yoghurt. The sensory profile of the yoghurts was also assessed by an informal tasting panel and was regarded as acceptable, demonstrating the utility of the compressed product in consumer product formulations.

### Example 12

### Production of Processed Cheese

Milk protein concentrate (MPC) powder was mixed with a concentrated milk fat composition (CMFC) of Example 2A and compressed to produce a unitised high density composition high fat milk protein concentrate (UHDC-HFMPC). The UHDC-HFMPC will be further processed at pilot scale into a processed cheese product. The processed cheese produced will then be assessed for firmness, melt and sensory characteristics and compared to typical processed cheese.

### 1. Materials

The MPC powder was produced at the Fonterra Research Centre (New Zealand) and passed through a conical screen mill. In one embodiment a target particle size distribution in the milling step is a d(0.5) value between 300 and 400 μm.

### 2. Method—Blending

The MPC and CMFC were batch blended using a 60 litre mechanical mixer. Each batch produced about 30 kg of mixture with a target of 30% added CMFC. The MPC was added to the blender at ambient temperature and mixed while the CMFC was added at about 55° C. Each batch was blended for 120 seconds to ensure that the mixture was homogenous. The target chemical composition of the mixture is shown in Table 8.

TABLE 8
Target composition

| Protein (w/w %) | Lactose | Minerals | Fat | Moisture |
|---|---|---|---|---|
| (N × 6.38) | (w/w %) | (w/w %) | (w/w %) | (w/w %) |
| 42 | 11.2 | 6.8 | 36.6 | 3.4 |

### 3. Method—Compaction

The mixture was compacted in 25 kg batches using a custom built hydraulic press. For each batch 25 kg of the mixture was weighed out, placed inside the press chamber and leveled out. The mixture was pressed between two platens from above and below (i.e. multi-directional compression) simultaneously.

Each compact was removed from the press and placed in a plastic liner and vacuum packaged. The vacuum packaged compacts were placed in cardboard cartons and stored at ambient while the product was demonstrated as food safe.

### 4. Method—Processed Cheese

The UHDC-HFMPC (3.44 kg) will be placed in a Blentech™ CC45 blender/cooker fitted with ribbon augers. The material will be blended for 1 minute at 50 rpm to break up the ingredient. Cheese (9.89 kg), unsalted butter (1.60 kg), trisodium citrate (0.72 kg), citric acid (0.06 kg), salt (0.25 kg) sorbic acid (0.02 kg) and water (1.63 kg) will be added and blending continued for 40 minutes. The mixture will be transferred to a second Blentech™ CC45 fitted with solid augers and the speed set to 120 rpm. The mixture will be heated to 87° C. over 5 minutes using direct steam injection. The hot product will be passed through a shear pump and then cast into slices. The cooled slices will be wrapped in plastic film and stored at 4° C. in heat sealed plastic bags.

After 7 days, the slices will be evaluated for firmness, melt and sensory characteristics. Firmness will be measured at 13° C. using a TA-HD Texture Analyser (Stable Micro Systems). The L.D. Schreiber melt test will be carried out to assess the properties of the product (5 minutes at 232° C.). Sensory characteristics will be assessed by an informal panel of experts.

### 5. Results

The texture and flavour of slices with respect to commercially processed cheese will be assessed to determine their similarity to commercial processed cheese slices.

### Example 13

### Use of Absorption and Solvent Extraction for Water Removal from HFC and for Separation of MFC and HFPC from CMFC

Three high fat creams (HFC) of about 80% fat by weight were produced according to Example 7. The HFCs were treated according to one of the following methods and inverted from an oil-in-water emulsion to a water-in-oil emulsion to form concentrated milk fat compositions (CMFCs). The three HFCs were also treated according to Example 2A to produce three CMFCs which were then treated according to one of the following methods to produce milk fat concentrate (MFC) and a high fat paste concentrate (HFPC). The techniques investigated in this example were absorption, liquid-liquid extraction, and supercritical extraction.

### 1. Methods

The three HFCs (control, washed and phospholipids enriched) were phase inverted in a 2-stage homogeniser (Rannie, Denmark) at 130 bar in a single homogenising stage to form water in oil emulsions. CMFCs were then produced from the inverted HFCs using two different techniques, those being contact with an absorbent and liquid-liquid extraction.

The three CMFCs (control, washed and phospholipids enriched) were separated into milk fat concentrate (MFC) and high fat paste concentrate (IUPC) using liquid-liquid extraction or supercritical extraction.

Absorption of HFC:

The absorbent (Ultratex 4 from National Starch, Auckland, New Zealand) was mixed directly with the HFCs and shaken overnight at 40° C. The samples were then heated to 50° C. and centrifuged at 3500 rpm for 5 minutes. A sample of each HFC without an absorbent added was also centrifuged.

Liquid-Liquid Extraction of HFC:

The solvents (AR grade hexane and HPLC grade ethyl acetate) were added to the molten HFCs at a ratio of 5 parts solvent to 1 part sample. The samples were shaken for 2 hours at 40° C. and then the HFC samples were centrifuged for 30-60 min at 7000 rpm. The pellet and supernatant fractions were rotary evaporated at 45° C. until all of the visible solvent had been removed. The samples were then rotary evaporated for a further 90 min at 45-50° C. The moisture content of the supernatant fraction was measured using Karl Fischer titration.

Liquid-Liquid Extraction of CMFC:

The solvents (AR grade acetone and food grade ethanol) were added to the molten CMFCs at a ratio of 5 parts solvent to 1 part sample. The samples were shaken for 2 hours at 40° C. and vacuum filtered while still warm through Whatman #1 filter paper. Two warm solvent washes of the filter cake were carried out followed by 15 min of additional vacuum filtration to dry the cake. The filtrate fractions were rotary evaporated at 45° C. until all of the visible solvent had been removed. A further 90 min of rotary evaporation at 45-50° C. was then carried out. The moisture content of the filtrate fraction was then measured using Karl Fischer titration and phospholipids content was measured on the filter cake using pNMR.

Supercritical Extraction of CMFC:

Anti-solvent extractions were carried out with supercritical CO₂. All CMFC samples were melted and continuously stirred at 50° C. The samples were pumped into the top of the extraction vessel through a 300 μm nozzle and the supercritical CO₂ flowed upwards through the bed in a counter-current flow to the feed. The CO₂ extractions were run at 300 bar and 50° C. with a feed flowrate of approximately 2% of the CO₂ flowrate. The extracts were measured for moisture content using Karl Fischer titration and the residues were analysed for phospholipids content using pNMR.

### 2. Results—HFC Absorption

After centrifugation the samples had separated into two layers, the pellet comprising the absorbent and the supernatant containing the fat phase. The supernatant was decanted from the pellet and its moisture content was measured using Karl Fischer titration.

TABLE 9
Use of absorption to remove water from HFCs

| | High Fat Cream (Centrifuged) | | |
|---|---|---|---|
| | (water % w/w) | | |
| | | | Phospholipids |
| | Control | Washed | Enriched |
| Untreated | 19.3 | 20.3 | 26.3 |
| No absorbent | 0.211 | 0.222 | 0.348 |
| UltraTex4 | 0.198 | 0.226 | 0.192 |

These results indicate that Ultratex 4 is capable of absorbing sufficient moisture to produce a CMFC from all three phase inverted HFCs.

### 3. Results—HFC Liquid-Liquid Extraction

TABLE 10
Use of liquid-liquid extraction to remove water from HFCs

| | | | % water |
|---|---|---|---|
| Sample | % Pellet | % Supernatant | (K. F.) |
| HFC Control Hexane | 2.81 | 77.40 | 0.039 |
| HFC Control Ethyl Acetate | 1.97 | 77.06 | 0.050 |
| HFC Washed Hexane | 1.34 | 79.53 | 0.040 |
| HFC Washed Ethyl Acetate | 5.84 | 76.19 | 0.036 |
| HFC Added P/L Hexane | 7.00 | 71.83 | 0.052 |
| HFC Added P/L Ethyl Acetate | 11.27 | 68.40 | 0.033 |

The results indicate that the hexane and the ethyl acetate are effective solvents for extracting the fat from the HFC. The moisture contents of all of the extracted fats were within the target range for a CMFC.

### 4. Results—CMFC Liquid-Liquid Extraction

TABLE 12
Use of liquid-liquid extraction to remove water from CMFCs

| | | | | Recovery of | |
|---|---|---|---|---|---|
| | | Mass % | Mass % P/L | P/L Filter | % Water |
| CMFC | Solvent | Filter Cake | Filter Cake | Cake (%) | Filtrate |
| Control | none | 17.50 | 1.51 | 100.00 | 0.055 |
| | ethanol | 0.79 | 1.13 | 3.40 | 0.019 |
| | acetone | 7.91 | 1.68 | 50.00 | 0.012 |
| Washed | none | 2.08 | 6.53 | 100.00 | 0.063 |
| | ethanol | 0.69 | 0.30 | 1.55 | 0.012 |
| | acetone | 0.78 | 26.79 | 153.64 | 0.006 |
| Phospholipid | none | 28.65 | 1.67 | 100.00 | 0.058 |
| Enriched | ethanol | 9.52 | 0.24 | 4.75 | 0.021 |
| | acetone | 4.27 | 10.67 | 95.34 | 0.013 |

These results demonstrate that the moisture content of the dissolved fat phase (filtrate) is reduced when compared to moisture content of the original CMFC. This suggests that a significant proportion of the moisture in the CMFC is bound up in the HFPC phase. Both of the solvents tested dissolved a significant proportion of the solid fat component of the CFMC, thereby reducing the fat content of the HFPC.

The phospholipids present in the CMFC are initially bound to the HFPC component. When treated with ethanol the majority (over 95%) of the phospholipids are transferred to the MFC component.

### 5. Results—CMFC Supercritical Extraction

TABLE 13
Use of supercritical extraction to remove water from CMFCs

| | | | | Recovery of | % |
|---|---|---|---|---|---|
| | | Mass % | Mass % P/L | P/L Filter | Water |
| CFMC | Solvent | Filter Cake | Filter Cake | Cake (%) | Filtrate |
| Control | CO₂ | 2.48 | 10.03 | 93.900 | 0.242 |
| Washed | CO₂ | 0.34 | 15.00 | 37.50 | 0.239 |
| Phospholipids | CO₂ | 0.84 | 12.25 | 21.50 | 1.392 |
| Enriched | | | | | |

Extraction with supercritical CO₂ resulted in a MFC with a higher moisture content than the original CMFC. This suggests that a significant proportion of the moisture in the CMFC remains with the MFC component, resulting in a comparatively dryer HFPC component after separation. The supercritical CO₂ dissolved greater than 80% of the HFPC component of the CMFC, thereby reducing the overall fat component of the HFPC. The supercritical CO₂ was unsuccessful in transferring a significant proportion of the phospholipids from the control CMFC to the MFC component. However greater than 60% of the phospholipids from the washed and phospholipids enriched CMFCs was transferred to the MFC component.

### Example 14

### Vacuum Drying of Concentrated Milk Fat Compositions

Three high fat creams (HFC) of about 80% fat by weight were produced according to Example 7 The three HFCs were treated according to Example 2A to produce three CMFCs which were then subjected to a vacuum drying step.

### 1. Methods

The three CMFCs (control, washed and phospholipids enriched) were vacuum dried using a two stage vacuum pump connected to a Buchi (BÜCHI Labortechnik Switzerland) rotary evaporator with a dry ice condenser. All samples were rotary evaporated in a 1 L round bottom flask at 61° C. and for 3.5-4 hrs. Vacuum measured at the condenser was 0 mbar absolute as seen on the V-800 vacuum controller.

All flasks were removed from the rotary evaporator using an argon purge. The samples were transferred to either a 250 ml or 500 ml container and stored under nitrogen in a dessicator in a cold room. The moisture content of the samples before and after vacuum drying was measured using Karl Fischer titrations.

### 2. Results

TABLE 14
Analysis of vacuum dried material

| | Karl Fischer Water Content (%) | |
|---|---|---|
| | Before Vacuum | After Vacuum |
| Sample | Drying | Drying |
| Control | 0.164 | 0.039 |
| Washed | 0.087 | 0.008 |
| Phospholipid | 0.194 | 0.033 |
| Enriched | | |

This example demonstrates that the production of concentrated milk fat compositions containing less than 0.01% moisture can be achieved if an additional vacuum drying step is undertaken.

### INDUSTRIAL APPLICABILITY

The described methods of producing concentrated milk fat compositions allow production of dairy lipid compositions for use in dairy products and other food products. The described lipid and protein products are also useful in dairy products and other food products.

Those persons skilled in the art will understand that the above description is provided by way of illustration only and that the invention is not limited thereto.

### REFERENCES

Buma, T J. (1965) The true density of spray dried powders and of certain constituents. Netherlands Milk and Dairy Journal 19, 249-265
Buma T J (1980). Viscosity and density of concentrated lactose solutions and of concentrated cheese whey. Netherlands Milk and Dairy Journal, 34, 1, 65-68.
Irvine T F & Liley P E (1984). Steam and gas tables with computer equations. Academic Press (Orlando).
Rahman, S (1995). Food properties handbook, CRC Press, Florida, USA.
Tetra Pak Dairy Processing Handbook, 2003, Tetra Pak Processing Systems AB, S-221 86 Lund, Sweden.

1. A method of producing a concentrated milk fat composition, the method comprising
(1) providing a high fat cream that is an oil-in-water emulsion comprising about 38 to about 85% by weight lipid and a moisture content of about 10 to about 62% by weight,
(2) heating the high fat cream to a temperature higher than the melting point of the lipid and lower than the smoke point of the lipid,
(3) subjecting the high fat cream to shear forces to convert the oil-in-water emulsion into a water-in-oil emulsion, and
(4) removing water from the high fat cream by evaporation, absorption, supercritical extraction or liquid-liquid extraction,
the concentrated milk fat composition being a water-in-oil emulsion comprising about 85 to about 99.5% by weight lipid and a moisture content of about 0.05 to about 15% by weight.

2. A method of claim 1 comprising heating high fat cream, subjecting the high fat cream to shear and removing water from the high fat cream in one step.

3. A method of claim 2 wherein the step comprises agitated thin film evaporation or wiped film evaporation.

4. A method of claim 1 comprising heating high fat cream in a first step, subjecting the high fat cream to shear forces in a second step and removing water from the high fat cream in a third step.

5. A method of claim 4 wherein the first step comprises steam infusion, direct steam injection or contacting the high fat cream with a heat exchanger, the second step comprises contacting the high fat cream with a homogeniser or a pump that subjects the high fat cream to shear forces, and the third step comprises liquid-liquid extraction, absorption, supercritical extraction, or evaporation with an evaporator.

6. A method of claim 5 wherein the liquid-liquid extraction comprises extraction with ethanol, hexane, acetone, carbon dioxide, dimethyl ether, or any combination of any two or more thereof.

7. A method of claim 5 wherein absorption comprises contacting the high fat cream with a desiccant selected from the group comprising a dietary fibre, modified starch, polydextrose, silica based powders or earths (including but not limited to diatomaceous earth and silica powders), activated carbon, inulin, and pectin, or any combination of any two or more thereof.

8. A method of claim 1 comprising heating high fat cream and subjecting the high fat cream to shear forces in a first step and removing water from the high fat cream in a second step or concurrently with the first step.

9. A method of claim 8 wherein the first step comprises direct steam injection, and the second step comprises liquid-liquid extraction, absorption, supercritical extraction or evaporation with an evaporator.

10. A method of claim 1 comprising heating high fat cream in a first step and subjecting the high fat cream to shear forces and removing water from the high fat cream in a second step or concurrently with the first step.

11. A method of claim 10 wherein the first step comprises steam infusion, direct steam injection or contacting the high fat cream with a heat exchanger, and the second step comprises flash evaporation, agitated thin film evaporation, or wiped film evaporation.

12. A method of producing a milk fat concentrate and a high fat paste concentrate, the method comprising
(1) providing a concentrated milk fat composition that is a water-in-oil emulsion comprising about 85% to about 99.5% by weight lipid and a moisture content of about 0.05 to about 15% by weight, at a temperature of about 17° C. to about 177° C., and optionally comprising an added source of phospholipid, and
(2) subjecting the concentrated milk fat composition to one or more separation steps to produce a high fat paste concentrate and a milk fat concentrate,
the high fat paste concentrate comprising about 1 to about 90% by weight lipid, about 0.1 to about 20% by weight moisture, and about 0.5 to about 35% by weight phospholipid,
the milk fat concentrate comprising about 99 to about 99.9% by weight lipid.

13. A method of claim 12 wherein the one or more separation steps comprises one or more of contacting the concentrated milk fat composition with a separator, liquid-liquid extraction, absorption, supercritical extraction or evaporation with an evaporator, or any combination of any two or more thereof.

14. A method of claim 13 wherein contacting the concentrated milk fat composition with a separator comprises contacting the concentrated milk fat composition with a plate and frame filter, a leaf filter, a basket centrifuge, a decanter, a centrifugal separator, or a belt filter, or any combination of any two or more thereof.

15. A method of producing a unitised high density composition, the method comprising
(1) providing a mixture comprising
(a) one or more liquid or semi-liquid milk fat compositions, and
(b) one or more milk powders, and
(2) compacting the mixture to produce a unitised high density composition having a volume of at least about 50 cm³ and a density of at least about 50% of the material density of the mixture.

16. A method of claim 15 wherein the one or more milk fat compositions and the one or more milk powders are mixed in a ratio of about 10:90 to about 45:55.

17. (canceled)

18. A method of claim 15 wherein the unitised high density composition has a solubility index of less than about 5 mL as determined according to ADMI Solubility Index Test IDF Standard 129A (1988).

19. (canceled)

20. A method of claim 15 wherein the unitised high density composition comprises about 1 to about 90% by weight protein.

21. A method of claim 15 wherein the unitised high density composition comprises about 1 to about 70% by weight lipid.

22. A method composition of claim 15 wherein the unitised high density composition comprises about 10 to about 60% by weight lipid and about 40 to about 90% by weight protein.

23. A method of claim 15 wherein the unitised high density composition comprises a volume of about 60 to about 100,000 cm³.

24. A method of claim 15 wherein the density of the unitised high density composition is about 55 to about 100% of the material density of the components of the composition.

25. A method of claim 15 wherein the unitised high density composition has a density of about 0.5 to about 1.5 g/ml.

26. (canceled)

27. (canceled)

28. A concentrated milk fat composition that is a water-in-oil emulsion comprising about 85 to 99.5% by weight milk lipid, about 0.1 to 5% by weight milk protein, about 0 to 5% by weight lactose and less than about 15% by weight moisture.

29. A high fat paste concentrate comprising at least about 1 to 90% by weight milk lipid, about 0.5 to about 35% by weight phospholipid, about 0.5 to 10% by weight milk protein, about 0 to 15% by weight lactose and less than about 20% by weight moisture.
